(19) United States
(12) Patent Application Publication
(10) Pub. No.: US 2025/0190433 A1
(43) Pub. Date: Jun. 12, 2025

(54) SEARCH DATA PROCESSING METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Aihu ZHANG, Shenzhen (CN); Zhiyi ZHOU, Shenzhen (CN)

(21) Appl. No.: 19/058,150

(22) Filed: Feb. 20, 2025

Related U.S. Application Data
(63) Continuation of application No. PCT/CN2023/130109, filed on Nov. 7, 2023.

(30) Foreign Application Priority Data
Feb. 13, 2023 (CN) 202310147291.6

(51) Int. Cl. G06F 16/2453; G06N 3/042

(52) U.S. Cl. CPC G06F 16/24534; G06N 3/042

(57) ABSTRACT

A search data processing method includes: obtaining a media search graph including a query node, a media node, and an association node; obtaining first training sample pairs, including a positive node pair and a negative node pair, from the media search graph, sampling the media search graph based on meta-paths respectively corresponding to the query and the media data, to obtain sampling sub-graphs; inputting the sampling sub-graphs to an initial graph neural network to obtain respective initial semantic features and form a semantic feature pair corresponding to the first training sample pair; and training the initial graph neural network based on a difference between semantic feature pairs of the positive node pair and the negative node pair, to obtain a target graph neural network that is configured to determine a target semantic feature corresponding to a query node or a media node.

### CROSS-REFERENCES TO RELATED APPLICATIONS

This application is a continuation application of PCT Patent Application No. PCT/CN2023/130109, filed on Nov. 7, 2023, which claims priority to Chinese Patent Application No. 2023101472916, filed on Feb. 13, 2023, all of which is incorporated herein by reference in their entirety.

### FIELD OF THE TECHNOLOGY

The present disclosure relates to the field of image processing technologies and, in particular, to a search data processing method and apparatus, a computer device, a storage medium, and a computer program product.

### BACKGROUND OF THE DISCLOSURE

With development of computer technologies, search functions appear in a variety of applications (APPs), and a user may search in an application for corresponding media data. For example, a user may perform a video search in a video application, and the user may perform a picture/image search and an article search in a social application.

Currently, feature extraction is usually directly performed on a query or media data to obtain a semantic feature corresponding to the query or the media data, and a search is performed based on the semantic feature corresponding to the query or the media data. However, the query or the media data often includes limited information. Consequently, the semantic feature is likely to be inaccurate, leading to inaccuracy of the search.

### SUMMARY

One embodiment of the present disclosure provides a search data processing method performed by a computer device. The method includes: obtaining a media search graph including a query node corresponding to a query, a media node corresponding to media data, and an association node corresponding to association data, the association data including data associated with at least one of the query or the media data; obtaining a plurality of first training sample pairs from the media search graph, the plurality of first training sample pairs including a positive node pair and a negative node pair, the positive node pair including a query node and a media node that are connected to each other in the media search graph, and the negative node pair including a query node and a media node that are randomly combined in the media search graph; sampling the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph; inputting, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair; and training the initial graph neural network based on a difference between semantic feature pairs corresponding to the positive node pair and the negative node pair, to obtain a target graph neural network, the target graph neural network being configured to determine a target semantic feature corresponding to a query node or a media node.

Another embodiment of the present disclosure provides a computer device. The computer device includes a memory and one or more processors, the memory containing computer-readable instructions that, when being executed, cause the one or more processors to perform: obtaining a media search graph including a query node corresponding to a query, a media node corresponding to media data, and an association node corresponding to association data, the association data including data associated with at least one of the query or the media data; obtaining a plurality of first training sample pairs from the media search graph, the plurality of first training sample pairs including a positive node pair and a negative node pair, the positive node pair including a query node and a media node that are connected to each other in the media search graph, and the negative node pair including a query node and a media node that are randomly combined in the media search graph; sampling the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph; inputting, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair; and training the initial graph neural network based on a difference between semantic feature pairs corresponding to the positive node pair and the negative node pair, to obtain a target graph neural network, the target graph neural network being configured to determine a target semantic feature corresponding to a query node or a media node.

Another embodiment of the present disclosure provides a non-transitory computer-readable storage medium containing computer-readable instructions that, when being executed, cause at least one processor to perform: obtaining a media search graph including a query node corresponding to a query, a media node corresponding to media data, and an association node corresponding to association data, the association data including data associated with at least one of the query or the media data; obtaining a plurality of first training sample pairs from the media search graph, the plurality of first training sample pairs including a positive node pair and a negative node pair, the positive node pair including a query node and a media node that are connected to each other in the media search graph, and the negative node pair including a query node and a media node that are randomly combined in the media search graph; sampling the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph; inputting, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair; and training the initial graph neural network based on a difference between semantic feature pairs corresponding to the positive node pair and the negative node pair, to obtain a target graph neural network, the target graph neural network being configured to determine a target semantic feature corresponding to a query node or a media node.

Details of one or more embodiments of the present disclosure are provided in the accompanying drawings and descriptions below. Other features, objectives, and advantages of the present disclosure become clear from the specification, the accompanying drawings, and the claims.

### BRIEF DESCRIPTION OF THE DRAWINGS

To describe the technical solutions in the embodiments of the present disclosure more clearly, the following briefly describes the accompanying drawings required for describing the embodiments. Clearly, the accompanying drawings in the following descriptions show merely some embodiments of the present disclosure, and a person of ordinary skill in the art may still derive other drawings from these accompanying drawings without creative efforts.

FIG. 1 is a diagram of an application environment of a search data processing method according to an embodiment of the present disclosure.

FIG. 2 is a schematic flowchart of a search data processing method according to an embodiment of the present disclosure.

FIG. 3A is a schematic diagram of an interface of a list-style search scenario according to an embodiment of the present disclosure.

FIG. 3B is a schematic diagram of an interface of an immersive search scenario according to an embodiment of the present disclosure.

FIG. 4 is a schematic diagram of a video search graph according to an embodiment of the present disclosure.

FIG. 5 is a schematic diagram of a semantic feature corresponding to a computing center node according to an embodiment of the present disclosure.

FIG. 6 is a schematic flowchart of training a graph neural network according to an embodiment of the present disclosure.

FIG. 7 is a schematic diagram of a positive sampling sub-graph pair and a negative sampling sub-graph pair according to an embodiment of the present disclosure.

FIG. 8 is a schematic flowchart of a search data processing method according to another embodiment of the present disclosure.

FIG. 9 is a schematic diagram of a two-tower search model according to an embodiment of the present disclosure.

FIG. 10 is a schematic flowchart of a one-tower search model according to an embodiment of the present disclosure.

FIG. 11 is a schematic architectural diagram of a search data processing method according to an embodiment of the present disclosure.

FIG. 12 is a schematic flowchart of a video search according to an embodiment of the present disclosure.

FIG. 13 is a structural block diagram of a search data processing apparatus according to an embodiment of the present disclosure.

FIG. 14 is a structural block diagram of a search data processing apparatus according to another embodiment of the present disclosure.

FIG. 15 is a structural block diagram of a search data processing apparatus according to another embodiment of the present disclosure.

FIG. 16 is a diagram of an internal structure of a computer device according to an embodiment of the present disclosure.

FIG. 17 is a diagram of an internal structure of a computer device according to another embodiment of the present disclosure.

### DESCRIPTION OF EMBODIMENTS

The technical solutions in the embodiments of the present disclosure are clearly and thoroughly described in the following with reference to the accompanying drawings in the embodiments of the present disclosure. Clearly, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The solutions provided in the embodiments of the present disclosure relate to artificial intelligence computer vision technologies, machine learning technologies, and the like, and are specifically described by using the following embodiments.

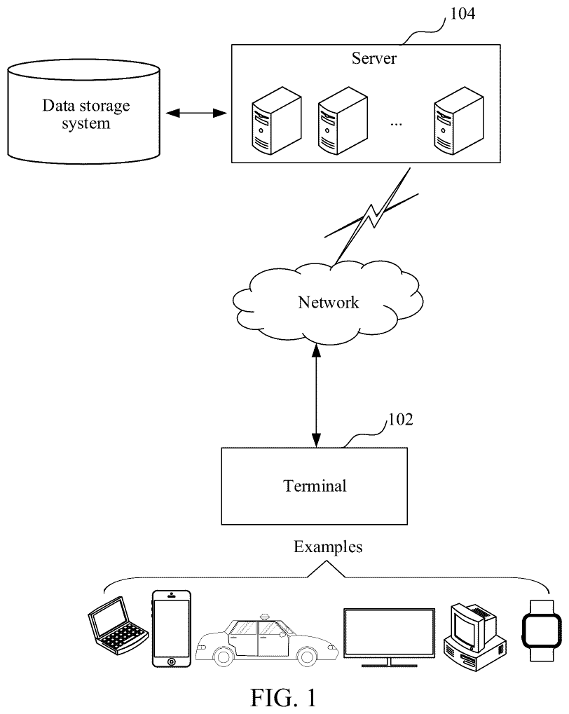

A search data processing method provided in the embodiments of the present disclosure may be applied to an application environment shown in FIG. 1. A terminal 102 communicates with a server 104 through a network. A data storage system may store data that the server 104 needs to process. The data storage system may be integrated in the server 104, or may be deployed on a cloud or another server. The terminal 102 may be but is not limited to a desktop computer, a notebook computer, a smartphone, a tablet computer, an Internet of Things device, and a portable wearable device. The Internet of Things device may be a smart speaker, a smart television, a smart air conditioner, a smart in-vehicle device, or the like. The portable wearable device may be a smart watch, a smart bracelet, a head-mounted device, or the like. The server 104 may be implemented by using an independent server, a server cluster including a plurality of servers, or a cloud server.

The terminal and the server may be separately configured to perform the search data processing method provided in the embodiments of the present disclosure.

For example, the server obtains a media search graph, and obtains a plurality of first training sample pairs from the media search graph. The media search graph includes a query node corresponding to a query (e.g., a search term), a media node corresponding to media data, and an association node corresponding to association data, and the association data includes data associated with at least one of the query and the media data. The plurality of first training sample pairs include a positive node pair and a negative node pair. The positive node pair includes a query node and a media node that are connected to each other in the media search graph. The negative node pair includes a query node and a media node that are randomly combined in the media search graph. The server samples the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph. The server inputs, to an initial graph neural network, the sampling sub-graphs respectively corresponding to the query node and the media node in the training sample pair, to obtain respective initial semantic features of the query node and the media node in the first training sample pair, and form a semantic feature pair corresponding to the first training sample pair; and trains the initial graph neural network based on a difference between semantic feature pairs respectively corresponding to the positive node pair and the negative node pair, to obtain a target graph neural network. The target graph neural network is configured to determine a target semantic feature corresponding to a query node or a media node.

The server obtains a sampling sub-graph corresponding to a target node, the target node including at least one of a query node and a media node, and the sampling sub-graph corresponding to the target node being obtained by sampling the media search graph. The server inputs, to the target graph neural network, the sampling sub-graph corresponding to the target node, to obtain a target semantic feature corresponding to the target node. The target semantic feature is used for a data search.

The terminal and the server may alternatively be configured to jointly perform the search data processing method provided in the embodiments of the present disclosure.

For example, the server obtains a media search graph from the terminal, and the server obtains a plurality of first training sample pairs from the media search graph. The server samples the media search graph based on meta-paths respectively corresponding to the query and the media data, to obtain sampling sub-graphs respectively corresponding to the query node and the media node in the first training sample pair. The server inputs, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair; and trains the initial graph neural network based on a difference between semantic feature pairs respectively corresponding to the positive node pair and the negative node pair, to obtain a target graph neural network.

The terminal transmits a search request to the server, the search request carrying a data identifier corresponding to at least one of a query and media data. The server determines a sampling sub-graph corresponding to a target node from the media search graph based on the data identifier. The server inputs, to the target graph neural network, the sampling sub-graph corresponding to the target node, to obtain a target semantic feature corresponding to the target node. The server determines a search result based on the target semantic feature corresponding to the target node. The server transmits the search result to the terminal.

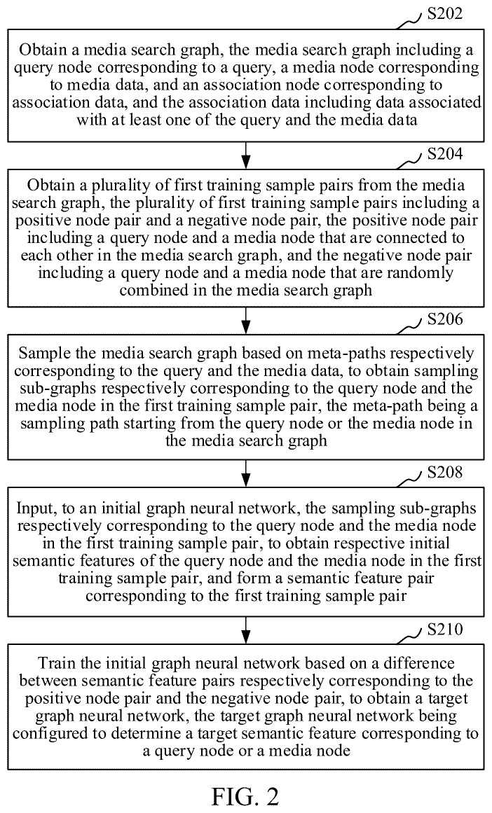

In an embodiment, as shown in FIG. 2, a search data processing method is provided. An example in which the method is applied to a computer device is used for description. The computer device may be a terminal or a server. The method may be performed by the terminal or the server alone, or the method may be implemented through interaction between the terminal and the server. As shown in FIG. 2, the search data processing method includes the following operations:

Operation S202: Obtain a media search graph. The media search graph includes a query node corresponding to a query, a media node corresponding to media data, and an association node corresponding to association data, and the association data includes data associated with at least one of the query and the media data.

The media search graph is a heterogeneous graph established based on a search consumption behavior of a search object for media data. The search object is an object that can trigger a search consumption behavior, namely, a search user. The search consumption behavior is a behavior of the search object for a search result during a search. For example, the search consumption behavior may be that the search user clicks/taps to play a video, or may be that the search user clicks/taps to browse an article.

The media search graph is a heterogeneous graph including a plurality of nodes and edges. The nodes in the media search graph include a query node corresponding to a query, a media node corresponding to media data, and an association node corresponding to association data. A connection relationship between a query node and a media node is determined based on a search consumption behavior. For example, if a user clicks/taps media data B in a search result of a query A, a connection relationship exists between a query node corresponding to the query A and a media node corresponding to the media data B, and a connecting edge exists between the query node and the media node. A connection relationship between a query node and an association node is determined based on an association relationship between a query and association data. For example, if the query A relates to association data C, a connection relationship exists between the query node corresponding to the query A and an association node corresponding to the association data C, and a connecting edge exists between the query node and the association node. A connection relationship between a media node and an association node is determined based on an association relationship between media data and association data. For example, if the media data B relates to the association data C, a connection relationship exists between the media node corresponding to the media data B and the association node corresponding to the association data C, and a connecting edge exists between the media node and the association node.

A search is performed based on a query to search for media data related to the query. For example, in a search engine, a user may enter “movie A” as a query. Then the search engine may search for media data based on the query and feed back media data related to the movie A. The query may be search text directly entered by a user in a search input box, or may be search text obtained by performing speech recognition on speech inputted by a user.

The media data includes at least one of text, an image, a video, and audio. For example, in a video application, a user may enter a query to search for a related video; in an audio application, a user may enter a query to search for related audio; and in an image application, a user may enter a query to search for a related image.

The association data includes data associated with at least one of the query and the media data. The association data may be at least one of an associated entity, an associated tag, an associated category, an associated publish object, and the like. The entity is an object that exists objectively and can be distinguished from other objects. The entity may be a specific person, event, or object, or may be a concept, and usually refers to a person name, a place name, or an agency name. There are also specific extensions in different fields, for example, a medicine name and a disease name in the medical field, and an IP name, a producer, and an editor in the film and television field. The media data has a corresponding tag. For example, if content of a video is a concert video of a singer A and the singer A is known as a handsome pop star, the video may be tagged as “singer A; handsome; pop star; concert”. The media data has a corresponding category. For example, articles may be classified into fun, food, fashion, tourism, entertainment, life, and gaming based on fields. The publish object is a publish user of the media data, for example, an author of an image.

Further, a node in the media search graph may further have a corresponding node feature. The node feature may be configured for describing attribute information corresponding to the node, or may be configured for describing statistical information of a search consumption behavior corresponding to the node. Further, A connecting edge in the media search graph may further have a corresponding connection feature. Similarly, the connection feature may be configured for describing attribute information corresponding to a connection relationship, or may be configured for describing statistical information of a search consumption behavior corresponding to the connection relationship.

Specifically, the computer device may obtain a media search graph locally or from another device; construct, based on the media search graph, training data for a graph neural network for extracting an image feature; train the graph neural network based on the training data; and extract, based on a trained graph neural network, an image feature of a sub-graph corresponding to a related node in the media search graph, to generate a semantic feature corresponding to the node. The semantic feature may be applied to a search task to improve search accuracy.

Operation S204: Obtain a plurality of first training sample pairs from the media search graph. The plurality of first training sample pairs include a positive node pair and a negative node pair. The positive node pair includes a query node and a media node that are connected to each other in the media search graph. The negative node pair includes a query node and a media node that are randomly combined in the media search graph.

A training sample pair is training data for a graph neural network. The first training sample pair is a node pair used for model training. The first training sample pair includes a positive node pair and a negative node pair. The positive node pair includes a query node and a media node that are connected to each other in the media search graph. The query node and the media node that are connected to each other in the media search graph are determined based on a search consumption behavior of a search object, and may indicate a search intention and a consumption preference of the search object. The query node and the media node that are connected to each other in the media search graph are used as the positive node pair to prompt the network to learn knowledge related to the search intention and the consumption preference of the search object. The negative node pair includes a query node and a media node that are randomly combined in the media search graph. The query node and the media node that are randomly combined are not related to the search consumption behavior of the search object. The query node and the media node that are randomly combined in the media search graph are used as the negative node pair to prompt the network to learn to distinguish between the positive node pair and the negative node pair, so that the network better learns knowledge related to the search intention and the consumption preference of the search object.

Specifically, the computer device may obtain a query node and a media node that are connected to each other from the media search graph as a positive node pair. The media search graph includes a plurality of query nodes and a plurality of media nodes, and a plurality of positive node pairs may be finally obtained. The computer device may obtain a query node and a media node that are randomly combined from the media search graph as a negative node pair. The media search graph includes a plurality of query nodes and a plurality of media nodes, and a plurality of negative node pairs may be finally obtained. The computer device performs self-supervised learning on the graph neural network based on the positive node pairs and the negative node pairs.

Operation S206: Sample the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph.

The meta-path is a specific path pattern for connecting two objects. For example, a meta-path is “query node->media data->query node”, and the meta-path indicates that one query node is connected to another query node through two hops. The meta-path is a manner of mining a similarity relationship between objects. The meta-path is a semantic embedding of a query node or a media node in the media search graph, and is used for data sampling. The meta-path is a sampling path starting from a query node or a media node in the media search graph. To be specific, a query node or a media node in the media search graph serves as a center node, and the meta-path is a sampling path starting from the center node.

In an embodiment, the meta-path is generally a specific path pattern in which two objects are sequentially connected through an object. The meta-path generally includes three sequentially connected type flags that represent node types. In other words, the meta-path is a path pattern formed by three sequentially connected type flags. The three type flags may be type flags of a same type. For example, the three type flags all represent a search type, and the meta-path is represented as “q->q->q”, q representing the search type. The three type flags may include two types of type flags. For example, the meta-path is represented as “q->i->q”, i representing a media type; or the meta-path is represented as “q->e->q”, e representing an entity type. The three type flags may include three types of type flags. For example, the meta-path is represented as “q->i->t”, t representing a tag type; or the meta-path is represented as “q->i->e”.

The meta-path is configured for sampling a matching node from the media search graph to generate a sampling sub-graph. Sampling a corresponding node path from the media search graph based on the path pattern of the meta-path to generate a sampling sub-graph means sampling nodes that are connected based on the path pattern of the meta-path from the media search graph to generate a sampling sub-graph. A sampling sub-graph includes a center node and a neighbor node. A node type corresponding to the center node belongs to a starting type flag in the meta-path. A node type corresponding to the neighbor node belongs to another type flag in the meta-path. In the sampling sub-graph, any node path from the center node to a leaf neighbor node is a meta-path. For example, the meta-path is “q->i->q”. Any query node belonging to the search type is obtained from the media search graph as a center node. A media node that belongs to the media type and that is directly connected to the center node is obtained from the media search graph as a first-order neighbor node. A query node that belongs to the search type and that is directly connected to the first-order neighbor node is obtained from the media search graph as a second-order neighbor node. A sampling sub-graph is generated based on the center node, the first-order neighbor node, and the second-order neighbor node that are connected based on the path pattern of the meta-path.

The query and the media data have corresponding meta-paths. In a meta-path corresponding to the query, a node type of a center node is the search type. In a meta-path corresponding to the media data, a node type of a center node is the media type.

Specifically, the computer device obtains the meta-path corresponding to the query, and samples the media search graph based on the meta-path corresponding to the query, to obtain a sampling sub-graph corresponding to the query node in the first training sample pair. The computer device obtains the meta-path corresponding to the media data, and samples the media search graph based on the meta-path corresponding to the media data, to obtain a sampling sub-graph corresponding to the media node in the first training sample pair.

The meta-path corresponding to the query includes at least one type of meta-path, and the meta-path corresponding to the media data includes at least one type of meta-path.

Operation S208: Input, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair.

The graph neural network is a graph-domain information processing network based on deep learning, and is a connectionist model for learning a graph including a large quantity of connections. Input data for the graph neural network is a sampling sub-graph corresponding to a node, and output data is a semantic feature corresponding to the node. A sampling sub-graph corresponding to a node is inputted to the graph neural network, and related features of neighbor nodes in the sampling sub-graph are aggregated to a center node through the graph neural network, to obtain a semantic feature corresponding to the center node. In a sampling sub-graph corresponding to a node, the node is a center node in the sampling sub-graph.

The initial graph neural network is a to-be-trained graph neural network. The initial semantic feature is a semantic feature outputted by the initial graph neural network.

One first training sample pair includes a pair of query node and media node. The query node has a corresponding initial semantic feature, and the media node has a corresponding initial semantic feature. The initial semantic features respectively corresponding to the query node and the media node in the first training sample pair form a semantic feature pair.

Specifically, the computer device inputs, to the initial graph neural network, the sampling sub-graph corresponding to the query node in the first training sample pair, to obtain the initial semantic feature corresponding to the query node in the first training sample pair. The computer device inputs, to the initial graph neural network, the sampling sub-graph corresponding to the media node in the first training sample pair, to obtain the initial semantic feature corresponding to the media node in the first training sample pair. Initial semantic features respectively corresponding to a query node and a media node in a same training sample pair form a semantic feature pair corresponding to the training sample pair.

In an embodiment, the graph neural network may be a graph convolutional network. The graph convolutional network performs data processing on an image through a convolution operation. There are many graph convolutional networks, for example, GraphSage (a spatial domain-based graph convolutional algorithm), a graph attention network (GAT), and a disentangled graph convolutional network (DisenGCN).

Operation S210: Train the initial graph neural network based on a difference between semantic feature pairs respectively corresponding to the positive node pair and the negative node pair, to obtain a target graph neural network, the target graph neural network being configured to determine a target semantic feature corresponding to a query node or a media node.

The target graph neural network is a trained graph neural network. The target semantic feature is a semantic feature outputted by the target graph neural network.

Specifically, after obtaining a semantic feature pair corresponding to each training sample pair, the computer device trains the initial graph neural network based on the difference between the semantic feature pairs respectively corresponding to the positive node pair and the negative node pair, to obtain the target graph neural network.

The computer device generates a network loss based on the difference between the semantic feature pairs respectively corresponding to the positive node pair and the negative node pair, and adjusts a network parameter of the initial graph neural network based on the network loss until a convergence condition is met, to obtain the target graph neural network. For example, overlapping nodes exist between a positive node pair and a negative node pair that match each other. A feature similarity between semantic features in a semantic feature pair corresponding to the positive node pair is calculated. A feature similarity between semantic features in a semantic feature pair corresponding to the negative node pair is calculated. A network loss is calculated based on a difference between feature similarities corresponding to the positive node pair and the negative node pair that match each other. The network parameter of the initial graph neural network is adjusted based on the network loss, to make the difference between the feature similarities corresponding to the positive node pair and the negative node pair that match each other increase. To be specific, a higher similarity between semantic features of a query node and a media node with a connecting edge indicates a lower similarity between semantic features of the query node and a media node without a connecting edge.

The convergence condition is a condition for determining whether the network reaches convergence. The convergence condition includes but is not limited to at least one of the following: The network loss is less than a preset loss value, a quantity of network iterations is greater than a preset quantity of iterations, a change rate of the network loss is less than a preset change rate, or the like.

For example, the computer device obtains a first training sample pair; inputs, to the initial graph neural network, sampling sub-graphs respectively corresponding to a query node and a media node in the first training sample pair, to obtain a semantic feature pair corresponding to the first training sample pair; calculates a network loss based on semantic feature pairs respectively corresponding to the positive node pair and the negative node pair; adjusts the initial graph neural network based on the network loss to obtain an intermediate graph neural network, and uses the intermediate graph neural network as an initial graph neural network; obtains a new first training sample pair; inputs the new first training sample pair to the new initial graph neural network to calculate a new network loss; adjusts the new initial graph neural network based on the new network loss to obtain a new intermediate graph neural network, and uses the intermediate graph neural network as an initial graph neural network; and returns to the operation of obtaining a first training sample pair, to continue to perform iterative training. If the preset quantity of iterations is 100, an intermediate graph neural network obtained through the 101^{st} adjustment is used as the target graph neural network.

The target graph neural network is configured to determine a target semantic feature corresponding to a query node or a media node. The target semantic feature corresponding to the query node or the media node may be applied to a search scenario, for example, a query-to-query (q2q) scenario, a query-to-item (q2i) scenario, an item-to-query (i2q) scenario, or an item-to-item (i2i) scenario.

In the q2q search scenario, semantic extension or rewriting is performed on a query currently entered by a user, to mine a latent search requirement implied by the query currently entered by the user, so that more abundant media data of possible interest can be subsequently provided for the user. For example, in the q2q search scenario, a sampling sub-graph of a query node corresponding to a query is inputted to the target graph neural network to obtain a target semantic feature corresponding to the query. Based on differences between a target semantic feature corresponding to a query A and target semantic features respectively corresponding to other queries, a related query corresponding to the query A is determined from the other queries, and the related query is used as a search result for the query A in the q2q scenario.

In the q2i search scenario, media data semantically related to a query inputted by a user is recalled. For example, in the q2i search scenario, a sampling sub-graph of a query node corresponding to a query is inputted to the target graph neural network to obtain a target semantic feature corresponding to the query, and a sampling sub-graph of a media node corresponding to media data is inputted to the target graph neural network to obtain a target semantic feature corresponding to the media data. Based on differences between a target semantic feature corresponding to a query A and target semantic features respectively corresponding to different media data, related media data corresponding to the query A is determined from the media data, and the related media data is used as a search result for the query A in the q2i scenario.

In the i2q search scenario, a query semantically related to media data currently consumed by a user is recalled, and the user is guided to perform a secondary search to meet a latent requirement of the user. For example, in the i2q search scenario, a sampling sub-graph of a media node corresponding to media data is inputted to the target graph neural network to obtain a target semantic feature corresponding to the media data, and a sampling sub-graph of a query node corresponding to a query is inputted to the target graph neural network to obtain a target semantic feature corresponding to the query. Based on differences between a target semantic feature corresponding to media data A and target semantic features respectively corresponding to queries, a related query corresponding to the media data A is determined from the queries, and the related query is used as a search result for the media data A in the i2q scenario.

In the i2i search scenario, semantically related media data is recommended for a user based on a consumption preference of the user for a list of currently recalled media data. For example, in the i2i search scenario, a sampling sub-graph of a media node corresponding to media data is inputted to the target graph neural network to obtain a target semantic feature corresponding to the media data. Based on differences between a target semantic feature corresponding to media data A and target semantic features respectively corresponding to other media data, related media data corresponding to the media data A is determined from the other media data, and the related media data is used as a search result for the media data A in the i2i scenario.

In the foregoing search data processing method, the media search graph includes not only a query node and a media node, but also an association node. The media search graph includes abundant information. Further, the media search graph is sampled based on a meta-path corresponding to a corresponding node, to obtain a sampling sub-graph corresponding to the corresponding node. The sampling sub-graph also includes abundant information. This helps improve accuracy of subsequent feature extraction. A sampling sub-graph corresponding to a node may be inputted to the target graph neural network obtained through training for feature extraction, to obtain a target semantic feature corresponding to the node. The target semantic feature includes node information corresponding to nodes in the sampling sub-graph, and therefore has high accuracy. This can also effectively improve accuracy of a subsequent search. In addition, during training of the graph neural network, a positive node pair includes a query node and a media node that are associated, and a negative node pair includes a query node and a media node that are unassociated. The graph neural network is trained based on a difference between semantic feature pairs respectively corresponding to the positive node pair and the negative node pair, so that accuracy of the graph neural network in feature extraction can be improved. Therefore, the graph neural network outputs similar semantic features for a query node and a media node that are associated, and outputs dissimilar semantic features for a query node and a media node that are unassociated. In this way, accuracy of a subsequent search based on a semantic feature can also be effectively improved.

In an embodiment, the obtaining a media search graph includes:
obtaining historical search information corresponding to a plurality of search objects, the historical search information including a historical query and positive media data corresponding to the historical query, and the positive media data being media data corresponding to a positive feedback by the search object; generating an object node corresponding to each search object, a query node corresponding to each historical query, and a media node corresponding to each piece of positive media data, establishing a connection relationship between the object node and a corresponding query node, establishing a connection relationship between the object node and a corresponding media node, and establishing a connection relationship between the query node and a corresponding media node; obtaining at least one type of association data corresponding to each of the historical query and the positive media data, the at least one type of association data including an associated entity, an associated tag, an associated category, or an associated publish object; generating an association node corresponding to each piece of association data, establishing a connection relationship between the query node and a corresponding association node, and establishing a connection relationship between the media node and a corresponding association node; obtaining a node feature corresponding to each node and a connection feature corresponding to each connection relationship; and generating the media search graph based on each node, the node feature corresponding to the node, a connection relationship between nodes, and a connection feature corresponding to the connection relationship.

The search object is a search user. The historical search information is search information determined based on a historical search consumption behavior of the search user, and is configured for indicating a historical search status of the search user. The historical search information includes a historical query and positive media data corresponding to the historical query. The historical query is a query used by the search user during a past search. The positive media data is media data corresponding to a positive feedback by the search object. In other words, the positive media data is media data, in a media data search result, that is consumed by a user. For example, for a media data search result corresponding to a query A entered by the user, the positive media data is media data clicked/tapped by the user.

In an embodiment, to enrich data in the media search graph, search logs corresponding to the search object in at least two search scenarios respectively are obtained, and historical search information is mined from the search logs. Further, data cleansing may be performed on the search logs to obtain historical search information. For example, search logs with key information missing are filtered out, where the key information includes three core elements: a search object, a historical query, and positive media data; and data with abnormal consumption duration is filtered out.

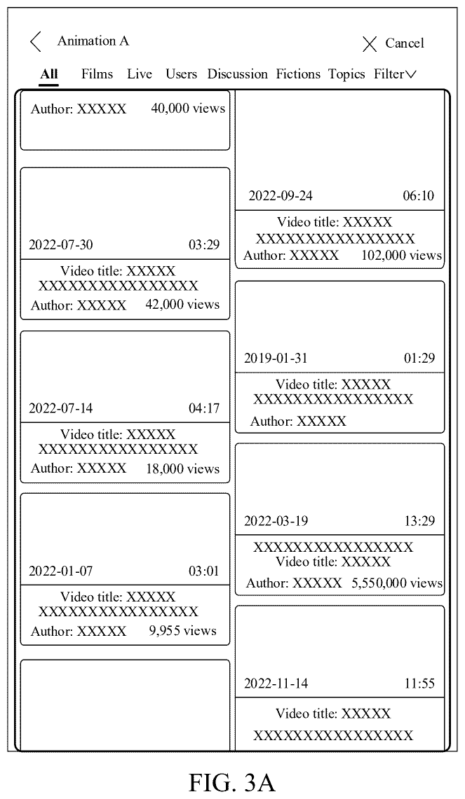

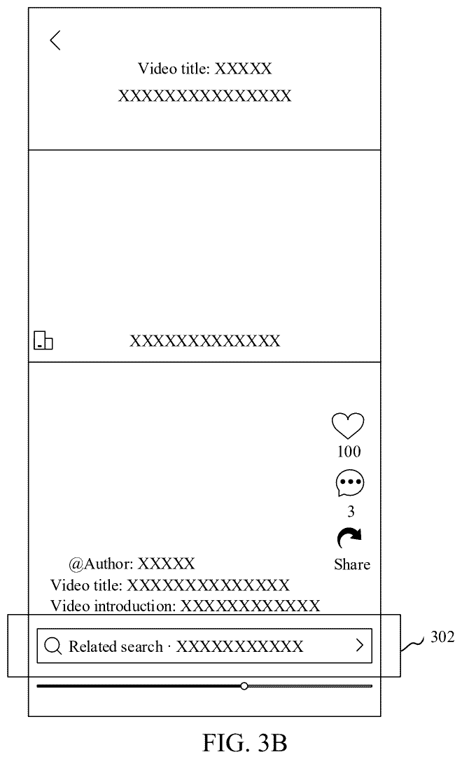

In an embodiment, to better mine true interest of a user, the positive media data includes media data with consumption duration greater than a duration threshold. Longer consumption time of the user for media data indicates that the user is more interested in the media data. Further, the positive media data includes at least one of media data with consumption duration greater than a first duration threshold in a list-style search scenario and media data with consumption duration greater than a second duration threshold in an immersive search scenario, where the first duration threshold is less than the second duration threshold. For example, a video meeting one of the following two conditions is considered as a positively consumed video: A user clicks/taps a video on a list-style search page, and play duration meets a duration threshold α; or duration within which a user plays a video on an immersive search page meets a duration threshold β, where α<β. The list-style search scenario is a search scenario in which a plurality of search results in a search result list are synchronously displayed in a list form. For example, FIG. 3A shows a video search result list page obtained after a user searches for an “animation A”. The user swipes up or swipes down on a search result list to view a search result, taps a video to enter a play page for consumption, and then returns from the play page and enters the list page again to continue to view another search result on the list page. The immersive search scenario is a search scenario in which a personalized search is performed based on a search result consumed by a user. For example, FIG. 3B shows a video play page obtained after a user taps a video search result for a query. After the user taps to enter the play page, an “immersive page search” is initiated. The scenario is a personalized search scenario. The user swipes up or swipes down on the play page to view other immersive search results of the personalized search. Further, 302 in FIG. 3B indicates a related query recalled for the user based on the video played in FIG. 3B, to guide the user to perform a secondary search to meet a latent requirement of the user.

The historical query and the positive media data have respective corresponding association data. The association data includes at least one of an associated entity, an associated tag, an associated category, and an associated publish object. In an embodiment, for the association data, to improve data accuracy, an entity with inaccurate entity recognition may be removed to prevent introduction of incorrect information, a category with a few occurrences may be removed to prevent non-confidence of category information, and publish objects may be normalized to normalize a plurality of publish accounts corresponding to one user into one account.

In addition to nodes and connection relationships between the nodes, the media search graph further includes node features corresponding to the nodes and connection features corresponding to the connection relationships. A node feature includes at least one of an attribute feature and a statistical feature that correspond to the node. A connection feature includes at least one of an attribute feature and a statistical feature that correspond to a connection relationship. The attribute feature is configured for indicating attribute information. The statistical feature is configured for indicating statistical information of a search consumption behavior.

A short video node is used as an example. A node feature of the short video node may be shown in Table 1.

TABLE 1

| Field | Type | Meaning |
|---|---|---|
| video_id | Attribute | Video ID |
| txt_fields_emb | Attribute | Embedding of text such as a video title, |
| | | a category, and a tag (from a BERT pre- |
| | | training model) |
| video_duration | Attribute | Video duration |
| freshness | Attribute | Video freshness score |
| quality_score | Attribute | Video quality score |
| play_num | Statistics | Quantity of times of play |
| like_num | Statistics | Quantity of likes |
| comment_num | Statistics | Quantity of comments |
| search_num_Nday | Statistics | Quantity of searches in which the video |
| | | was clicked/tapped in the last N days |
| uniq_user_Nday | Statistics | Quantity of search users who clicked/ |
| | | tapped the video in the last N days |
| click_Nday | Statistics | Quantity of clicks/taps in search |
| | | scenarios in the last N days |
| playvv_Nday | Statistics | Quantity of video views in search |
| | | scenarios in the last N days |
| playtime_Nday | Statistics | Total play duration in search scenarios in |
| | | the last N days |
| completerate_Nday | Statistics | Average play completion rate in search |
| | | scenarios in the last N days |
| fullplaynum_Nday | Statistics | Quantity of play completions in search |
| | | scenarios in the last N days |
| fastslipnum_Nday | Statistics | Quantity of times of fast swiping in |
| | | search scenarios in the last N days |

Specifically, the computer device obtains historical search information respectively corresponding to a plurality of search objects, generates an object node corresponding to each search object, a query node corresponding to each historical query, and a media node corresponding to each piece of positive media data by using the search objects, historical queries, and positive media data as basic graph composition elements, establishes a connection relationship between the object node and a corresponding query node, establishes a connection relationship between the object node and a corresponding media node, and establishes a connection relationship between the query node and a corresponding media node. The media search graph is established based on object nodes, query nodes, media nodes, and connection relationships between corresponding nodes. For example, for a historical query qy of a search object ux and media data iz that is positively consumed in a search result for the historical query qy, nodes respectively corresponding to ux, qy, and iz are constructed, and the ux, qy, and iz nodes are added to graph composition, with a connecting edge between every two of the nodes.

Further, the association data corresponding to the historical query and the positive media data may be used as an additional graph composition element. The computer device obtains at least one type of association data corresponding to each of the historical query and the positive media data, generates an association node corresponding to each piece of association data, establishes a connection relationship between the query node and a corresponding association node, and establishes a connection relationship between the media node and a corresponding association node. Association nodes and connection relationships corresponding to the association nodes are added to the media search graph.

Further, each element in the media search graph may have a corresponding element feature. The computer device obtains a node feature corresponding to each node and a connection feature corresponding to each connection relationship, and adds the node feature and the connection feature to the media search graph, where the node feature is used as node information, and the connection feature is used as connection relationship information.

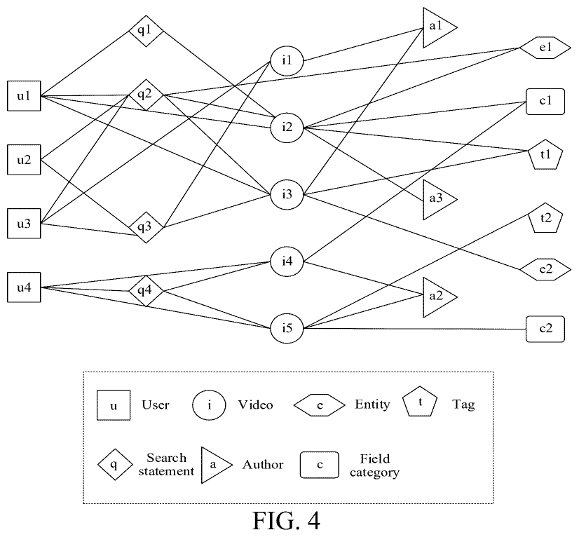

For example, FIG. 4 is a schematic diagram of a video search graph. The video search graph includes a video node representing a video, a user node representing a search user, a query node representing a query, an author node representing a video author, a category node representing a video field category, an entity node representing an entity in a video or a query, and a tag node representing a video tag. The video node is a media node. The user node is an object node. The author node, the category node, the entity node, and the tag node are association nodes of different types.

In the foregoing embodiment, core nodes of the media search graph are constructed based on core elements in three search scenarios: a search object, a query, and media data; and association nodes associated with the core node are introduced into the media search graph, so that the entire graph includes quite abundant information. Such a media search graph helps improve accuracy of subsequent data processing.

In an embodiment, before the generating an association node corresponding to each piece of association data, the search data processing method further includes:
obtaining supplementary media data, and generating a media node corresponding to the supplementary media data, the supplementary media data including at least one of first media data and second media data, the first media data being media data with media quality higher than a quality threshold, and the second media data being media data with a time interval between publish time and current time less than a first time interval threshold; and obtaining at least one type of association data corresponding to the supplementary media data.

Specifically, to ensure media data coverage of the media search graph, media data that does not appear in the historical search information may be further used as supplementary media data, and the supplementary media data may be used as an additional graph composition element. The supplementary media data is additionally supplemented media data. The supplementary media data includes at least one of the first media data and the second media data. The first media data is media data with media quality higher than the quality threshold. In other words, the first media data is high-quality media data. The high-quality media data is media data with a quality score reaching a specific threshold. The second media data is media data with a time interval between publish time and current time less than the first time interval threshold. In other words, the second media data is fresh media data. The fresh media data is media data whose publish time is within a short time interval from a current moment, for example, within a week. The computer device obtains the supplementary media data, generates a media node corresponding to the supplementary media data, and adds, to the media search graph, the media node corresponding to the supplementary media data. Further, the computer device may further obtain at least one type of association data corresponding to the supplementary media data, add, to the media search graph, an association node corresponding to the association data of the supplementary media data, and add, to the media search graph, a connection relationship between nodes respectively corresponding to the supplementary media data and the association data of the supplementary media data.

The quality threshold and the first time interval threshold may be set according to an actual requirement.

In the foregoing embodiment, high-quality or fresh media data is added to the media search graph, so that media data coverage of the media search graph can be ensured, and the entire graph includes quite abundant information. Such a media search graph helps improve accuracy of subsequent data processing.

In an embodiment, the search data processing method further includes:
obtaining a rewritten query corresponding to the historical query; when a search time interval between the historical query and the corresponding rewritten query is less than a second time interval threshold and a similarity between the historical query and the corresponding rewritten query is greater than a similarity threshold, generating a query node corresponding to the rewritten query; and establishing a connection relationship between the query node corresponding to the historical query and the query node corresponding to the rewritten query.

The rewritten query is a query rewritten by a search user during a search. For example, a user enters a query A to perform a search. When the user is unsatisfied with a search result, the user actively changes the query to perform a search again. A query B used after the change is a rewritten query corresponding to the query A.

A similarity between different queries is configured for representing how similar different queries are. A higher similarity indicates that different queries are more similar to each other. A similarity between queries may be calculated by using various similarity calculation algorithms. For example, a rate of character overlapping between queries may be calculated as a similarity; or text features of queries may be extracted, and data representing a distance between the text features, for example, a cosine distance or a Euclidean distance between the text features, may be calculated as a similarity.

Specifically, to further improve information abundance of the media search graph, a rewritten query corresponding to a historical query may be further used as an additional graph composition element. The computer device obtains a rewritten query corresponding to a historical query, generates a query node corresponding to the rewritten query, and adds the query node to the media search graph.

Further, to ensure accuracy of information in the media search graph, a rewritten query corresponding to a historical query is selectively added to the media search graph. The computer device may filter rewritten queries, generate a query node corresponding to a selected rewritten query, and add the query node to the media search graph. During filtering, if a search time interval between a historical query and a corresponding rewritten query is less than the second time interval threshold and a similarity between the historical query and the corresponding rewritten query is greater than the similarity threshold, a query node corresponding to the rewritten query is generated, a connection relationship between a query node corresponding to the historical query and the query node corresponding to the rewritten query is established, and the new query node and the connection relationship are added to the media search graph.

The second time interval threshold may be set according to an actual requirement.

In the foregoing embodiment, based on a query rewriting behavior of a search object, a rewritten query that has a high similarity and whose search time is within a specific interval is added to the media search graph, so that query coverage of the media search graph can be ensured, and the entire graph includes quite abundant information. Such a media search graph helps improve accuracy of subsequent data processing.

In an embodiment, the sampling the media search graph based on meta-paths respectively corresponding to the query and the media data, to obtain sampling sub-graphs respectively corresponding to the query node and the media node in the training sample pair includes:
determining a current search meta-path from at least one meta-path corresponding to the query, the current search meta-path being a path formed by sequentially connecting type flags respectively corresponding to a search type, a first type, and a second type; and sampling, by using a current query node as a search center node, at least two nodes that are directly connected to the search center node and that belong to the first type from the media search graph as a first-order neighbor node corresponding to the search center node, sampling at least two nodes that are directly connected to the first-order neighbor node and that belong to the second type from the media search graph as a second-order neighbor node corresponding to the search center node, and obtaining a sampling sub-graph corresponding to the search center node in the current search meta-path based on the search center node and the corresponding first neighbor node second neighbor node; and
determining a current media meta-path from at least one meta-path corresponding to the media data, the current media meta-path being a path formed by sequentially connecting type flags respectively corresponding to a media type, a third type, and a fourth type; and sampling, by using a current media node as a center media node, at least two nodes that are directly connected to the center media node and that belong to the third type from the media search graph as a first-order neighbor node corresponding to the center media node, sampling at least two nodes that are directly connected to the first-order neighbor node and that belong to the fourth type from the media search graph as a second-order neighbor node corresponding to the center media node, and obtaining a sampling sub-graph corresponding to the center media node in the current media meta-path based on the center media node and the corresponding first neighbor node second neighbor node.

The meta-path is a path pattern formed by three sequentially connected type flags. The search meta-path is a meta-path corresponding to the query. The current search meta-path is a currently processed search meta-path, and may be any one of the at least one meta-path corresponding to the query. The current search meta-path includes sequentially connected type flags that represent the search type, the first type, and the second type. The first type and the second type may have a same type flag or different type flags. The first type and the second type may be the search type or other types.

Similarly, the media meta-path is a meta-path corresponding to the media data. The current media meta-path is a currently processed media meta-path, and may be any one of the at least one meta-path corresponding to the media data. The current media meta-path includes sequentially connected type flags that represent the media type, the third type, and the fourth type. The third type and the fourth type may have a same type flag or different type flags. The third type and the fourth type may be the media type or other types.

In an embodiment, meta-paths corresponding to the query may be shown in Table 2, and meta-paths corresponding to the media data may be shown in Table 3.

TABLE 2

| Meta-path | Physical meaning |
|---|---|
| q-i-a | This meta-path indicates that media data published by a |
| | specific author is positively consumed in a specific query. |
| | This may represent that a user wants to view media data of |
| | a specific author after searching for a specific query. |
| q-i-c | This meta-path indicates that media data belonging to a |
| | specific type is positively consumed in a specific query. |
| | This may represent that a user wants to view media data of |
| | a specific type after searching for a specific query. |
| q-i-e | This meta-path indicates that media data involving a specific |
| | entity is positively consumed. This may represent that a user |
| | wants to view media data about a specific entity after |
| | searching for a specific query. |
| q-i-t | This meta-path indicates that media data with a specific tag |
| | is positively consumed. This may represent that a user wants |
| | to view media data with a specific tag after searching for a |
| | specific query. |
| q-i-q | Specific media data is jointly played on demand in two |
| | queries. This may represent that the two queries are similar |
| q-u-q | Two queries are searched for by a same user. This may |
| | represent that the two queries are associated. |
| q-e-q | A specific entity is mentioned in two queries. This may |
| | represent that the two queries are similar |

TABLE 3

| Meta-path | Physical meaning |
|---|---|
| i-q-i | Two pieces of media data are found in a same query and are |
| | positively consumed. This may represent that the two pieces |
| | of media data are similar. |
| i-u-i | Two pieces of media data are positively consumed by a same |
| | user. This may represent that the two pieces of media data |
| | are associated. |
| i-a-i | The two pieces of media data come from a same author. This |
| | may represent that the two pieces of media data are similar. |
| i-e-i | A specific entity is mentioned in two pieces of media data. |
| | This may represent that the two pieces of media data are |
| | similar. |
| i-t-i | Two pieces of media data have a specific tag. This may |
| | represent that the two pieces of media data are similar. |
| i-c-i | Two pieces of media data belong to a same field category. |
| | This may represent that the two pieces of media data are |
| | similar. |

The current query node is a currently processed query node, and may be any query node in the media search graph. The current media node is a currently processed media node, and may be any media node in the media search graph.

Specifically, the computer device samples nodes that are connected based on the path pattern of the meta-path from the media search graph to generate a sampling sub-graph. The current search meta-path is used as an example. The first type flag in the current search meta-path represents the search type, and the computer device uses the current query node as a search center node. In a finally generated sampling sub-graph, a center node is the current query node. The second type flag in the current search meta-path is the first type, and the computer device samples, from the media search graph, at least two nodes that are directly connected to the search center node and that belong to the first type as first-order neighbor nodes corresponding to the search center node. In the finally generated sampling sub-graph, a connection relationship exists between the search center node and the first-order neighbor nodes. The third type flag in the current search meta-path is the second type, and the computer device samples, from the media search graph, at least two nodes that are directly connected to the first-order neighbor nodes and that belong to the second type as second-order neighbor nodes corresponding to the search center node. Each first-order neighbor node has a corresponding second-order neighbor node. In the finally generated sampling sub-graph, a connection relationship exists between a first-order neighbor node and a corresponding second-order neighbor node. Finally, the computer device constructs, based on the search center node and the corresponding first-order neighbor nodes and second-order neighbor nodes, a sampling sub-graph corresponding to the search center node in the current search meta-path.

The current media meta-path is used as an example. The first type flag in the current media meta-path represents the media type, and the computer device uses the current media node as a media center node. In a finally generated sampling sub-graph, a center node is the current media node. The second type flag in the current media meta-path is the third type, and the computer device samples, from the media search graph, at least two nodes that are directly connected to the media center node and that belong to the third type as first-order neighbor nodes corresponding to the media center node. In the finally generated sampling sub-graph, a connection relationship exists between the media center node and the first-order neighbor nodes. The third type flag in the current media meta-path is the fourth type, and the computer device samples, from the media search graph, at least two nodes that are directly connected to the first-order neighbor nodes and that belong to the fourth type as second-order neighbor nodes corresponding to the media center node. Each first-order neighbor node has a corresponding second-order neighbor node. In the finally generated sampling sub-graph, a connection relationship exists between a first-order neighbor node and a corresponding second-order neighbor node. Finally, the computer device constructs, based on the media center node and the corresponding first-order neighbor nodes and second-order neighbor nodes, a sampling sub-graph corresponding to the media center node in the current media meta-path.

In the foregoing embodiment, nodes connected based on the path pattern of the meta-path are sampled from the media search graph to generate a sampling sub-graph. The sampling sub-graph includes a plurality of first-order neighbor nodes and a plurality of second-order neighbor nodes, so that information abundance of the sampling sub-graph can be improved. In addition, the neighbor nodes help better indicate features of a center node from different perspectives. Such a sampling sub-graph can include more accurate features of the center node. This helps improve accuracy of subsequent data processing.

In an embodiment, the inputting, to an initial graph neural network, the sampling sub-graphs respectively corresponding to the query node and the media node in the first training sample pair, to obtain respective initial semantic features of the query node and the media node in the first training sample pair includes:
inputting, to the initial graph neural network, sampling sub-graphs from at least two semantic perspectives that correspond to a current node, to obtain respective sub-graph features of the sampling sub-graphs corresponding to the current node, the current node being the query node or the media node in the first training sample pair, and different meta-paths corresponding to different semantic perspectives; and fusing the sub-graph features corresponding to the current node, to obtain an initial semantic feature corresponding to the current node.

Different meta-paths correspond to different path patterns, and different path patterns are to mine search requirements of users from different semantic perspectives. For example, refer to Table 2. The seven meta-paths in Table 2 respectively correspond to different semantic perspectives.

Specifically, in view of complexity and node type diversity of the media search graph, to improve network robustness, at least two meta-paths are designed for each of a query node and a media node. Different meta-paths correspond to different semantic perspectives, and sub-graph sampling surrounding a center node may be performed along different meta-path directions. Regardless of whether a node is a query node or a media node, at least two sampling sub-graphs may be finally obtained through sampling. During image feature extraction for sampling sub-graphs, feature extraction manners for sampling sub-graphs corresponding to a query node and a media node are the same. A current node is a query node or a media node. A feature extraction process is described by using the current node as an example. The computer device inputs, to the initial graph neural network, a sampling sub-graph corresponding to the current node, and the initial graph neural network aggregates related node information of neighbor nodes in the sampling sub-graph to a center node, to obtain a sub-graph feature of the sampling sub-graph corresponding to the current node. The sampling sub-graph corresponding to the current node includes sampling sub-graphs from at least two semantic perspectives. Through processing by the initial graph neural network, respective sub-graph features of the sampling sub-graphs corresponding to the current node may be finally obtained. Further, the computer device fuses the respective sub-graph features of the sampling sub-graphs corresponding to the current node, to finally obtain an initial semantic feature corresponding to the current node. A fusion method may be addition, averaging, an attention mechanism, or the like.

A fusion operation may be performed in or out of the graph neural network.

In the foregoing embodiment, the initial semantic feature corresponding to the current node is obtained by fusing respective sub-graph features of sampling sub-graphs of the current node that are from different semantic perspectives, and therefore includes more abundant information, can more accurately express semantic information of the current node, and has higher accuracy. This also helps improve search accuracy.

In an embodiment, a sampling sub-graph corresponding to a node includes the node and a first-order neighbor node and a second-order neighbor node that correspond to the node, and the inputting, to the initial graph neural network, sampling sub-graphs from at least two semantic perspectives that correspond to a current node, to obtain respective sub-graph features of the sampling sub-graphs corresponding to the current node includes:
aggregating, to a first-order neighbor node by using the initial graph neural network, a node feature corresponding to a second-order neighbor node in a current sampling sub-graph corresponding to the current node, and a connection feature between the second-order neighbor node and the first-order neighbor node, to obtain a second-order aggregated feature corresponding to the first-order neighbor node; aggregating, to the current node by using the initial graph neural network, a node feature corresponding to the first-order neighbor node, the second-order aggregated feature, and a connection feature between the first-order neighbor node and the current node, to obtain a first-order aggregated feature corresponding to the current node; and obtaining, by using the initial graph neural network based on the node feature corresponding to the current node and the first-order aggregated feature, a sub-graph feature of the current sampling sub-graph corresponding to the current node.

The current sampling sub-graph is a currently processed sampling sub-graph, and may be any one of sampling sub-graphs from different semantic perspectives that correspond to the current node.

Specifically, the graph neural network performs a same feature extraction operation on sampling sub-graphs, and the graph neural network performs the feature extraction operation along a reverse direction of a meta-path. The current sampling sub-graph corresponding to the current node is used as an example. The computer device inputs the current sampling sub-graph to the initial graph neural network. In the initial graph neural network, a node feature corresponding to a second-order neighbor node in the current sampling sub-graph and a connection feature between the second-order neighbor node and a first-order neighbor node are first aggregated to the first-order neighbor node, to obtain a second-order aggregated feature corresponding to the first-order neighbor node. Then a node feature corresponding to the first-order neighbor node, the second-order aggregated feature, and a connection feature between the first-order neighbor node and the current node are aggregated to the current node, to obtain a first-order aggregated feature corresponding to the current node. Finally, a node feature corresponding to the current node and the first-order aggregated feature are fused to obtain a sub-graph feature of the current sampling sub-graph corresponding to the current node.

During aggregation, features are fused to obtain an aggregated feature. For example, weighted summation is performed on the features to obtain the aggregated feature, and a weight is determined based on a network parameter.

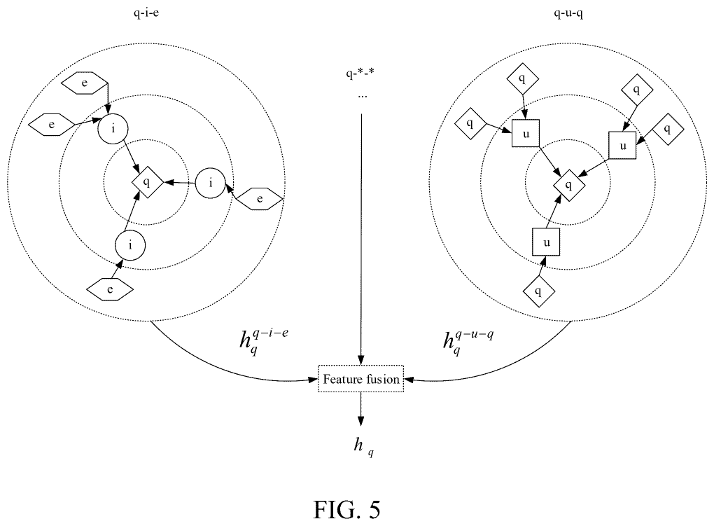

For example, refer to FIG. 5. q-i-e is used as an example. First, related features of outermost e nodes (namely, second-order neighbor nodes) of a sampling sub-graph are aggregated to corresponding i nodes (namely, first-order neighbor nodes). Then related features of the i nodes are aggregated to a center node q, to obtain a sub-graph feature of the center node q from the perspective of q-i-e, namely, a sub-graph embedding h_{q}^{q-i-e} of the center node q from the perspective of q-i-e. q-u-q is used as an example. First, related features of outermost q nodes (namely, second-order neighbor nodes) of a sampling sub-graph are aggregated to corresponding u nodes (namely, first-order neighbor nodes). Then related features of the u nodes are aggregated to a center node q, to obtain a sub-graph feature of the center node q from the perspective of q-u-q, namely, a sub-graph embedding h_{q}^{q-u-q} of the center node q from the perspective of q-u-q. Further, after feature extraction is performed on sampling sub-graphs of a same center node q that are from a plurality of semantic perspectives, sub-graph features of the center node q from the plurality of semantic perspectives, namely, a multi-perspective semantic embedding of the center node q, are obtained. After the sub-graph features of the center node q from the semantic perspectives are fused, a final semantic feature h_{q} of the center node q is obtained.

In the foregoing embodiment, a sub-graph feature of a sampling sub-graph is generated by aggregating related information of neighbor nodes in the sampling sub-graph to a center node. During network training, neighbor information is continuously aggregated, and then iterative updates are performed. As a quantity of iterations increases, aggregated information of each node is generally global. This helps improve quality of model training and further improve accuracy of extraction of semantic features corresponding to nodes, so that accuracy of a subsequent search is improved.

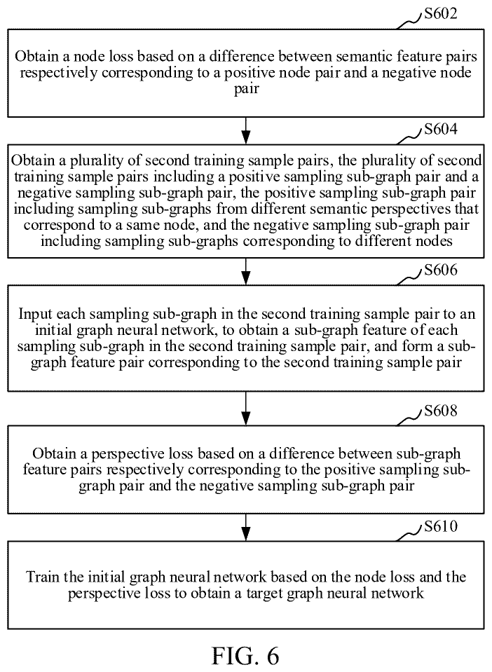

In an embodiment, as shown in FIG. 6, the training the initial graph neural network based on a difference between semantic feature pairs respectively corresponding to the positive node pair and the negative node pair, to obtain a target graph neural network includes the following operations:

Operation S602: Obtain a node loss based on the difference between the semantic feature pairs respectively corresponding to the positive node pair and the negative node pair.

The node loss is configured for representing a difference between a feature correlation between nodes in the positive node pair and a feature correlation between nodes in the negative node pair. An objective of training the network is to maximize the feature correlation between the nodes in the positive node pair and minimize the feature correlation between the nodes in the negative node pair. In this way, the network can output semantic features that are as similar as possible for a query and media data that match each other, and can output semantic features that are as dissimilar as possible for a query and media data that do not match each other.

Specifically, training data for the network includes the first training sample pair. A training mode based on the first training sample pair is a supervised learning mode based on a search consumption behavior. In a search scenario, a search consumption behavior of a user may be directly used as a supervision signal. For the first training sample pair, sampling sub-graphs respectively corresponding to a query node and a media node in the first training sample pair are inputted to the initial graph neural network, to obtain respective initial semantic features of the query node and the media node in the first training sample pair, and form a semantic feature pair corresponding to the first training sample pair. The computer device calculates the node loss based on the difference between the semantic feature pairs respectively corresponding to the positive node pair and the negative node pair.

Operation S604: Obtain a plurality of second training sample pairs. The plurality of second training sample pairs include a positive sampling sub-graph pair and a negative sampling sub-graph pair. The positive sampling sub-graph pair includes sampling sub-graphs from different semantic perspectives that correspond to a same node. The negative sampling sub-graph pair includes sampling sub-graphs corresponding to different nodes.

The second training sample pair is a sampling sub-graph pair used for model training. The second training sample pair includes a positive sampling sub-graph pair and a negative sampling sub-graph pair. The positive sampling sub-graph pair includes sampling sub-graphs from different semantic perspectives that correspond to a same node. The negative sampling sub-graph pair includes sampling sub-graphs corresponding to different nodes. Although a plurality of sampling sub-graphs of a same node are from different perspectives, a correlation between the sampling sub-graphs is quite high. A correlation between sub-graph embeddings of different nodes is low even if the sub-graph embeddings are from a same perspective.

Operation S606: Input each sampling sub-graph in the second training sample pair to the initial graph neural network, to obtain a sub-graph feature of each sampling sub-graph in the second training sample pair, and form a sub-graph feature pair corresponding to the second training sample pair.

Operation S608: Obtain a perspective loss based on a difference between sub-graph feature pairs respectively corresponding to the positive sampling sub-graph pair and the negative sampling sub-graph pair.

A second training sample pair includes a pair of sampling sub-graphs. The sampling sub-graph has a corresponding sub-graph feature. Sub-graph features respectively corresponding to the sampling sub-graphs in the second training sample pair form a sub-graph feature pair.

The perspective loss is configured for representing a difference between a feature correlation between sampling sub-graphs in the positive sampling sub-graph pair and a feature correlation between sampling sub-graphs in the negative sampling sub-graph pair. An objective of training the network is to maximize the feature correlation between the sampling sub-graphs in the positive sampling sub-graph pair and minimize the feature correlation between the sampling sub-graphs in the negative sampling sub-graph pair, so that the network outputs significantly different sub-graph features for different nodes.

Specifically, training data for the network further includes the second training sample pair, and a training mode based on the second training sample pair is a multi-perspective contrastive learning mode. For the second training sample pair, the computer device inputs each sampling sub-graph in the second training sample pair to the initial graph neural network, to obtain a sub-graph feature of each sampling sub-graph in the second training sample pair, and form a sub-graph feature pair corresponding to the second training sample pair. The computer device calculates the perspective loss based on the difference between the sub-graph feature pairs respectively corresponding to the positive sampling sub-graph pair and the negative sampling sub-graph pair.

The perspective loss may include at least one of a perspective loss corresponding to a query node or a perspective loss corresponding to a media node. For a perspective loss corresponding to a query, the positive sampling sub-graph pair includes sampling sub-graphs from different semantic perspectives that correspond to a same query node, and the negative sampling sub-graph pair includes sampling sub-graphs corresponding to different query nodes. For a perspective loss corresponding to a media node, the positive sampling sub-graph pair includes sampling sub-graphs from different semantic perspectives that correspond to a same media node, and the negative sampling sub-graph pair includes sampling sub-graphs corresponding to different media nodes.

Operation S610: Train the initial graph neural network based on the node loss and the perspective loss to obtain the target graph neural network.

Specifically, to further improve training quality for the network, joint training is performed by combining the supervised learning method based on search consumption behaviors and the multi-perspective contrastive learning method. The computer device obtains a fusion network loss based on the node loss and the perspective loss, and trains the initial graph neural network based on the fusion network loss to obtain the target graph neural network.

In the foregoing embodiment, training is performed based on the node loss and the perspective loss, so that the network can learn more general knowledge in search scenarios, to guide a model toward multivariate optimization, and fully mine in-depth semantic information included in a media search graph that is a heterogeneous graph. The consideration of the perspective loss in the multi-perspective contrastive learning can further alleviate data sparsity and enhance model robustness.

In an embodiment, the obtaining a node loss based on the difference between the semantic feature pairs respectively corresponding to the positive node pair and the negative node pair includes:
obtaining, based on a feature similarity between initial semantic features in a same semantic feature pair, a semantic similarity corresponding to the semantic feature pair; fusing semantic similarities respectively corresponding to a same positive node pair and corresponding negative node pairs, to obtain a fusion similarity corresponding to the positive node pair, a negative node pair corresponding to the positive node pair being a negative node pair having an overlapping node with the positive node pair; obtaining, based on a difference between a semantic similarity and a fusion similarity that correspond to a same positive node pair, a node sub-loss corresponding to the positive node pair; and obtaining the node loss based on a node sub-loss corresponding to each positive node pair.

The feature similarity is configured for representing how similar different initial semantic features are. A higher similarity indicates that different initial semantic features are more similar to each other. A feature similarity between features may be calculated by using various similarity calculation algorithms. For example, data representing a distance between features, for example, a cosine distance or a Euclidean distance, may be calculated as a feature similarity; or a ratio of intersection elements to union elements between features may be calculated as a feature similarity.

Specifically, the computer device calculates, based on a feature similarity between initial semantic features in a same semantic feature pair, a semantic similarity corresponding to the semantic feature pair, where the semantic similarity is positively correlated with the feature similarity. The computer device fuses semantic similarities respectively corresponding to a positive node pair and negative node pairs corresponding to the positive node pair, to obtain a fusion similarity corresponding to the positive node pair. For example, the semantic similarities are added up to obtain the fusion similarity, or weighted summation is performed on the semantic similarities to obtain the fusion similarity. The computer device obtains, based on a difference between a semantic similarity and a fusion similarity that correspond to a same positive node pair, a node sub-loss corresponding to the positive node pair. For example, a ratio of the semantic similarity to the fusion similarity is used as the node sub-loss, or a specific multiple of the ratio of the semantic similarity to the fusion similarity is used as the node sub-loss. The computer device summarizes node sub-losses respectively corresponding to different positive node pairs to finally obtain the node loss.

A training sample pair includes a large quantity of positive node pairs and negative node pairs. Correspondences exist between the positive node pairs and the negative node pairs. A negative node pair having an overlapping node with a positive node pair is a negative node pair corresponding to the positive node pair. An objective of training the network is as follows: A semantic feature outputted by the network for a query is maximally similar to a semantic feature outputted by the network for positive media data corresponding to the query, and the semantic feature outputted by the network for the query is maximally dissimilar to a semantic feature outputted by the network for other media data. Therefore, a correspondence is established between a positive node pair and a negative node pair that have overlapping nodes.

In an embodiment, a formula for calculating the node loss is as follows:

$${y}_{q , i} = {h}_{q}^{T} * {h}_{i} \\ {y}_{q , {i}^{′}} = {h}_{q}^{T} * {h}_{{i}^{′}} \\ {y}_{{q}^{′} , i} = {h}_{{q}^{′}}^{T} * {h}_{i} \\ {p}_{q , i} = \frac{exp ( {y}_{q , i} / τ )}{exp ( {y}_{q , i} / τ ) + {\sum }_{{i}^{′}} exp ( {y}_{q , {i}^{′}} / τ ) + {\sum }_{{q}^{′}} exp ( {y}_{{q}^{′} i} / τ )} \\ {L}_{sl} = - {\sum }_{( q , i )} log ( {p}_{q , i} )$$

In the media search graph, a (q, i) connecting edge sources from a historical search consumption behavior of a user, and is a natural supervision signal. A plurality of (q, i) edges are sampled from the media search graph as positive node pairs. For each (q, i) positive node pair, a plurality of q are randomly sampled from the media search graph to replace q in the positive node pair, to obtain a plurality of (q′, i) as negative node pairs, and a plurality of i are randomly sampled from the media search graph to replace i in the positive node pair, to obtain (q, i′) as negative node pairs.

h_{q} represents an initial semantic feature corresponding to a query node q. hᵢ represents an initial semantic feature corresponding to media data i. h_{q}^{T} represents a transposition of h_{q}·y_{q,i} represents a feature similarity between initial semantic features in the (q, i) positive node pair.

h_{q′} represents an initial semantic feature corresponding to a query q′·h_{q′}^{T} represents a transposition of h_{q′}·y_{q′,i}, represents a feature similarity between initial semantic features in the (q′, i) negative node pair.

h_{i′} represents an initial semantic feature corresponding to media data i′·y_{q,i′} represents a feature similarity between initial semantic features in the (q, i′) negative node pair.

p_{q,i} represents a node sub-loss corresponding to the positive node pair. exp( ) represents an exponential function with a natural constant e as a base. τ represents an adjustment parameter, which may be preset or may be a learnable parameter in the network. exp(y_{q,i}/τ) represents a semantic similarity corresponding to the (q, i) positive node pair. Σ_{i′} exp(y_{q,i′}/τ) represents a semantic similarity corresponding to the (q, i′) negative node pair. Σ_{q′} exp(y_{q′i}/τ) represents a semantic similarity corresponding to the (q′, i) negative node pair.

Lₛₗ represents a node loss.

In the foregoing embodiment, the node loss calculated in this way can guide the network to learn to distinguish between a positive node pair and a negative node pair that have a correspondence, so that the network outputs similar semantic features for a query and media data that are semantically similar, and outputs dissimilar semantic features for a query and media data that are semantically dissimilar.

In an embodiment, the obtaining a perspective loss based on a difference between sub-graph feature pairs respectively corresponding to the positive sampling sub-graph pair and the negative sampling sub-graph pair includes:
obtaining, based on a feature similarity between sub-graph features in a same sub-graph feature pair, a perspective similarity corresponding to the sub-graph feature pair; fusing perspective similarities respectively corresponding to a same positive sampling sub-graph pair and corresponding negative sampling sub-graph pairs, to obtain a fusion similarity corresponding to the positive sampling sub-graph pair; obtaining, based on a difference between a perspective similarity and a fusion similarity that correspond to a same positive sampling sub-graph pair, a perspective sub-loss corresponding to the positive sampling sub-graph pair; and obtaining the perspective loss based on a perspective sub-loss corresponding to each positive sampling sub-graph pair.

Specifically, the computer device calculates, based on a feature similarity between sub-graph features in a same sub-graph feature pair, a perspective similarity corresponding to the sub-graph feature pair, where the perspective similarity is positively correlated with the feature similarity. The computer device fuses perspective similarities respectively corresponding to a positive sampling sub-graph pair and negative sampling sub-graph pairs corresponding to the positive sampling sub-graph pair, to obtain a fusion similarity corresponding to the positive sampling sub-graph pair. For example, the perspective similarities are added up to obtain the fusion similarity, or weighted summation is performed on the perspective similarities to obtain the fusion similarity. The computer device obtains, based on a difference between a perspective similarity and a fusion similarity that correspond to a same positive sampling sub-graph pair, a perspective sub-loss corresponding to the positive sampling sub-graph pair. For example, a ratio of the perspective similarity to the fusion similarity is used as the perspective sub-loss, or a specific multiple of the ratio of the perspective similarity to the fusion similarity is used as the perspective sub-loss. The computer device summarizes perspective sub-losses respectively corresponding to different positive sampling sub-graph pairs to finally obtain the perspective loss.

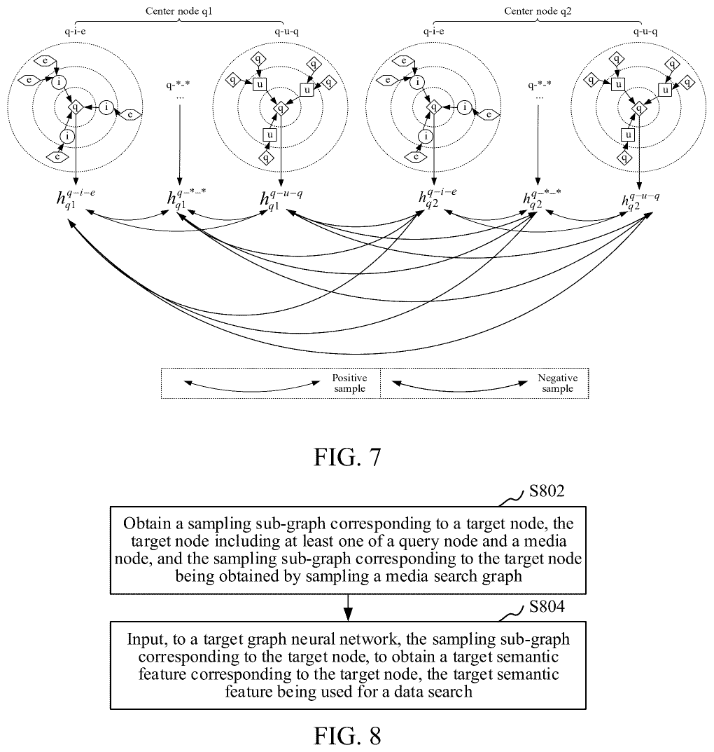

The second training sample pair includes a large quantity of positive sampling sub-graph pairs and negative sampling sub-graph pairs. An objective of training the network is to distinguish between sub-graph features outputted for any different nodes. Therefore, for a positive sampling sub-graph pair, a negative node pair may be randomly obtained as a negative sampling sub-graph pair corresponding to the positive sampling sub-graph pair. For example, as shown in FIG. 7, for a center node q1, sampling sub-graphs from different perspectives form positive samples in pairs (namely, positive sampling sub-graph pairs), and for a center node q2, sampling sub-graphs from different perspectives form positive samples in pairs. A sampling sub-graph of the center node q1 from any perspective and a sampling sub-graph of the center node q2 from any perspective form a negative sample (a negative sampling sub-graph pair).

In an embodiment, a formula for calculating the perspective loss is as follows:

$${Z}_{bi , bj} = \frac{{h}_{bi}^{T} * {h}_{bj}}{‖ {h}_{bi} ‖ * ‖ {h}_{bj} ‖} \\ {L}_{cl} = - {\sum }_{i , j ∈ MP , i \neq j} {\sum }_{b ∈ B} log \frac{exp ( {Z}_{bi , bj} / τ )}{exp ( {Z}_{bi , bj} / τ ) + {\sum }_{{b}^{′} , {b}^{′} \neq b} exp ( {Z}_{bi , {b}^{′} j} / τ )}$$

B represents a node set corresponding to a training batch, and MP is a perspective set (namely, a meta-path set). bi and bj represent two different perspectives for a node b. h_{bi} represents a sub-graph feature of the node b from a perspective i. h_{bj} represents a sub-graph feature of the node b from a perspective j. ∥h_{bi}∥ represents a length of h_{bi}, and ∥h_{bj}∥ represents a length of h_{bj}. Z_{bi,bj} represents a feature similarity corresponding to a positive sampling sub-graph pair. b′j represents a sub-graph feature of a node b′ from the perspective j. Z_{bi,b′j} represents a feature similarity corresponding to a negative sampling sub-graph pair. The negative sampling sub-graph pair and the positive sampling sub-graph pair correspond to a same perspective.

L_{cl} represents a perspective loss. exp( ) represents an exponential function with a natural constant e as a base. τ represents an adjustment parameter, which may be preset or may be a learnable parameter in the network. exp(Z_{bi,bj}/τ) represents a perspective similarity corresponding to the positive sampling sub-graph pair. exp(Z_{bi,b′j}/τ) represents a perspective similarity corresponding to the negative sampling sub-graph pair.

In the foregoing formula, exp(Z_{bi,b′j}/τ) may alternatively be replaced with exp(Z_{bi,b′k}/τ)·b′k represents a sub-graph feature of the node b′ from a perspective k. exp(Z_{bi,b′k}/τ) represents a perspective similarity corresponding to the negative sampling sub-graph pair. The negative sampling sub-graph pair and the positive sampling sub-graph pair correspond to different perspectives.

In the foregoing embodiment, the perspective loss calculated in this way can guide the network to learn to distinguish between a positive sampling sub-graph pair and a negative sampling sub-graph pair, so that the network outputs dissimilar sub-graph features for sampling sub-graphs belonging to different nodes.

In an embodiment, as shown in FIG. 8, a search data processing method is provided. An example in which the method is applied to a computer device is used for description. The computer device may be a terminal or a server. The method may be performed by the terminal or the server alone, or the method may be implemented through interaction between the terminal and the server. As shown in FIG. 8, the search data processing method includes the following operations:

Operation S802: Obtain a sampling sub-graph corresponding to a target node. The target node includes at least one of a query node and a media node. The sampling sub-graph corresponding to the target node is obtained by sampling a media search graph.

The target node is a node whose semantic feature is to be extracted. The target node may be a query node. For example, the target node may be a query node corresponding to a query for which a search result is to be determined. The target node may alternatively be a media node. For example, the target node may be a media node corresponding to candidate media data, and the candidate media data is media data for determining whether the media data is to be used as a search result for a query.

The media search graph is sampled based on a meta-path to obtain a sampling sub-graph corresponding to the target node. If the target node exists in the media search graph, the media search graph is directly sampled based on the meta-path to obtain the corresponding sampling sub-graph. If the target node does not exist in the media search graph, a node most similar to the target node may be obtained from the media search graph as a reference node, and a sampling sub-graph corresponding to the reference node is obtained by sampling the media search graph based on the meta-path and used as the sampling sub-graph corresponding to the target node. The node most similar to the target node may be obtained based on a feature similarity between node features.

For a process of constructing the media search graph, refer to content of the foregoing related embodiments. Details are not described herein again.

Operation S804: Input, to a target graph neural network, the sampling sub-graph corresponding to the target node, to obtain a target semantic feature corresponding to the target node. The target semantic feature is used for a data search.

The target graph neural network is a trained graph neural network. For processes of training and using a graph neural network, refer to content of the foregoing embodiments. Details are not described herein again.

Specifically, the computer device obtains the sampling sub-graph corresponding to the target node locally or from another device, and inputs, to the target graph neural network, the sampling sub-graph corresponding to the target node, and the target graph neural network performs feature extraction on the sampling sub-graph and outputs the target semantic feature corresponding to the target node.

A target semantic feature corresponding to a query node or a media node may be applied to a data search. For example, the target semantic feature corresponding to the query node may be applied to a q2q scenario, the target semantic feature corresponding to the media node may be applied to an i2i scenario, or both the target semantic feature corresponding to the query node and the target semantic feature corresponding to the media node may be applied to a q2i scenario and an i2q scenario.

In the foregoing search data processing method, a training sample pair for the graph neural network includes a positive node pair and a negative node pair. The positive node pair includes a query node and a media node that are connected to each other in the media search graph. The negative node pair includes a query node and a media node that are randomly combined in the media search graph. The media search graph includes not only a query node and a media node, but also an association node. The media search graph includes abundant information. Further, the media search graph is sampled based on a meta-path corresponding to a corresponding node, to obtain a sampling sub-graph corresponding to the corresponding node. The sampling sub-graph also includes abundant information. This helps improve accuracy of subsequent feature extraction. During training of the graph neural network, the positive node pair includes a query node and a media node that are associated, and the negative node pair includes a query node and a media node that are unassociated. The graph neural network is trained based on a difference between semantic feature pairs respectively corresponding to the positive node pair and the negative node pair, so that accuracy of the graph neural network in feature extraction can be improved. Therefore, the graph neural network outputs similar semantic features for a query node and a media node that are associated, and outputs dissimilar semantic features for a query node and a media node that are unassociated. In this way, accuracy of a subsequent search based on a semantic feature can also be effectively improved. A sampling sub-graph corresponding to a node may be inputted to the target graph neural network obtained through training for feature extraction, to obtain a target semantic feature corresponding to the node. The target semantic feature includes node information corresponding to nodes in the sampling sub-graph, and therefore has high accuracy. This can also effectively improve accuracy of a subsequent search. Search accuracy is improved, so that a waste of physical resources for implementing the search can be reduced, and utilization of the physical resources is improved. The physical resource herein is, for example, a server resource or a network bandwidth resource.

In an embodiment, the search data processing method further includes:
obtaining a target semantic feature corresponding to current search data of a current search object as a current search feature, and obtaining a target semantic feature corresponding to candidate search data as a candidate search feature, the current search data being a current query or current media data, and the candidate search data being a candidate query or candidate media data; and determining, based on a feature similarity between the current search feature and the candidate search feature, target search data from a plurality of pieces of candidate search data as a search result corresponding to the current search data.

The current search object is a search user who currently triggers a data search. For example, the current search object may be a user who enters a query to actively trigger a media data search, or the current search object may be a user who browses media data to passively trigger a search for a query.

The current search data is search data determined based on a current search behavior of the current search object. The current search data may be a current query. The current query is a query currently entered by a search object. For example, the current query is a query entered by a user in a search box. The current search data may be current media data. The current media data is media data currently browsed by a search object. For example, the current media data is a video currently played by a user.

The candidate search data is candidate search data for determining a search result for the current search data. A search result corresponding to the current search data is determined from a plurality of pieces of candidate search data. The candidate search data may be a candidate query or candidate media data.

In a q2q scenario, the current search data is a current query, the candidate search data is a candidate query, and a query search result corresponding to the current query is determined from a plurality of candidate queries. In a q2i scenario, the current search data is a current query, the candidate search data is candidate media data, and a media data search result corresponding to the current query is determined from a plurality of pieces of candidate media data. In an i2i scenario, the current search data is current media data, the candidate search data is candidate media data, and a media data search result corresponding to the current media data is determined from a plurality of pieces of candidate media data. In an i2q scenario, the current search data is current media data, the candidate search data is a candidate query, and a query search result corresponding to the current media data is determined from a plurality of candidate queries.

The target search data is a search result.

Specifically, to determine a search result corresponding to the current search data of the current search object, the computer device may obtain, based on the target graph neural network, the target semantic feature corresponding to the current search data and the target semantic feature corresponding to the candidate search data, and determine a search result for the current search data from a plurality of pieces of candidate search data based on the target semantic features.

The computer device obtains the target semantic feature corresponding to the current search data as a current search feature, obtains the target semantic feature corresponding to the candidate search data as a candidate search feature, and determines, based on a feature similarity between the current search feature and the candidate search feature, target search data from a plurality of pieces of candidate search data as a search result for the current search data. For example, at least one piece of candidate search data with a lowest feature similarity is obtained from the plurality of pieces of candidate search data as the target search data, or candidate search data with a feature similarity lower than a similarity threshold is obtained from the plurality of pieces of candidate search data as the target search data.

In the foregoing embodiment, a target semantic feature outputted by the target graph neural network for a query or media data can be applied to a data search based on the query or the media data, to improve search accuracy. Search accuracy is improved, so that a waste of physical resources for implementing the search can be reduced, and utilization of the physical resources is improved.

In an embodiment, the determining, based on a feature similarity between the current search feature and the candidate search feature, target search data from a plurality of pieces of candidate search data as a search result corresponding to the current search data includes:
obtaining target semantic features respectively corresponding to at least two pieces of positive media data corresponding to the current search object; fusing the target semantic features respectively corresponding to the at least two pieces of positive media data, to obtain a target object feature corresponding to the current search object; fusing the target object feature and the current search feature to obtain a fusion search feature; and determining, based on a feature similarity between the fusion search feature and the candidate search feature, target search data from a plurality of pieces of candidate search data as a search result corresponding to the current search data.

The positive media data corresponding to the current search object is media data positively consumed by the current search object. For example, the positive media data is a video that has been played by the user and whose play duration is greater than a duration threshold.

The target object feature is a feature embedding corresponding to a search object.

Specifically, to improve matching between a search result and a user, a user preference may be further modeled. For example, in a personalized search scenario, a user preference may be modeled to return a personalized search result to the user. The computer device may obtain target semantic features respectively corresponding to at least two pieces of positive media data corresponding to the current search object, and fuse the target semantic features respectively corresponding to the at least two pieces of positive media data, to obtain a target object feature corresponding to the current search object. For example, target semantic features of a plurality of videos recently positively consumed by a user are obtained, and the target semantic features are averaged and normalized to obtain a target object feature of the user. The computer device fuses the target object feature of the current search object and the target semantic feature corresponding to the current search data of the current search object to obtain a fusion search feature including a user preference and semantic information of the current search data, and determines, based on a feature similarity between the fusion search feature and the target semantic feature of the candidate search data, target search data from a plurality of pieces of candidate search data as a search result corresponding to the current search data.

In the foregoing embodiment, a target object feature of a search object is generated based on a target semantic feature corresponding to media data positively consumed by the search object, so that the target object feature includes media data preference information of the search object. During a data search, the target object feature corresponding to the search object is further considered, so that a search result can match the search object, to obtain a personalized search result. In addition, a waste of physical resources for implementing the search can be reduced, and utilization of the physical resources is improved.

In an embodiment, the search data processing method further includes:
inputting, to a first processing branch in a two-tower search model, a candidate search feature corresponding to each piece of candidate search data, to obtain a first search feature corresponding to the candidate search data; inputting the current search feature to a second processing branch in the two-tower search model, to obtain a second search feature; inputting the first search feature and the second search feature to an output layer in the two-tower search model, to obtain a first matching degree between each piece of candidate search data and the current search data; and determining, based on the first matching degree, the target search data from the candidate search data as the search result corresponding to the current search data.

The two-tower search model is a machine learning model including two branches. The two-tower search model includes two towers, and the two towers may separately perform data processing. Input data for the two-tower search model includes target semantic features corresponding to different search data, and output data is a matching degree between different search data.

The two-tower search model includes the first processing branch, the second processing branch, and the output layer. The candidate search feature corresponding to the candidate search data and the current search feature corresponding to the current search data are inputted to the two-tower search model. The first processing branch in the two-tower search model is configured to process the candidate search feature corresponding to the candidate search data, and the second processing branch is configured to process the current search feature corresponding to the current search data. The first processing branch and the second processing branch are configured to further extract features, to enhance expression capabilities of the features. The output layer is configured to calculate a matching degree between features outputted by the first processing branch and the second processing branch. Dedicated two-tower search models may be configured for different search scenarios, so that each search scenario has a corresponding two-tower search model, to improve search accuracy.

The first matching degree is a matching degree outputted by the two-tower search model. The matching degree is configured for representing a matching degree between different search data. A higher matching degree indicates that a higher semantic similarity between different search data.

Specifically, the computer device may determine a search result by using the two-tower search model. The computer device inputs, to the first processing branch of the two-tower search model, the candidate search feature corresponding to each piece of candidate search data, to obtain the first search feature corresponding to the candidate search data through data processing by the first processing branch; and inputs the current search feature to the second processing branch of the two-tower search model, to obtain the second search feature through data processing by the second processing branch. The computer device inputs the first search feature and the second search feature to the output layer of the two-tower search model, to obtain the first matching degree between each piece of candidate search data and the current search data through data processing by the output layer. Finally, the computer device determines, based on the first matching degree, the target search data from the candidate search data as the search result corresponding to the current search data. For example, a higher first matching degree indicates higher matching. At least one piece of candidate search data with a highest first matching degree is obtained from a plurality of pieces of candidate search data as the target search data, or candidate search data with a first matching degree higher than a matching degree threshold is obtained from a plurality of pieces of candidate search data as the target search data.

The candidate search feature and the current search feature may be synchronously inputted to the two-tower search model, or the candidate search feature and the current search feature may be inputted to the two-tower search model at different moments.

In the foregoing embodiment, during a data search, a search result is determined by using the two-tower search model, so that an accurate search result can be quickly obtained based on a powerful inference capability of the machine learning model, to improve search accuracy. Search accuracy is improved, so that a waste of physical resources for implementing the search can be reduced, and utilization of the physical resources is improved.

In an embodiment, the inputting the current search feature to a second processing branch in the two-tower search model, to obtain a second search feature includes:
inputting, to the second processing branch in the two-tower search model, the target object feature corresponding to the current search object and the current search feature, to obtain the second search feature.

Specifically, to improve matching between a search result and a user, the target object feature corresponding to the current search object and the current search feature may be inputted to the second processing branch of the two-tower search model, to obtain the second search feature through data processing by the second processing branch. The second search feature includes user preference information. During subsequent determining of target search data from candidate search data, the user preference information can be considered, to obtain personalized target search data for the user.

In the foregoing embodiment, during a data search, a target object feature of a search object is further inputted to the two-tower search model to determine a search result, so that a search result that not only matches semantics of current search data but also matches a current search object can be obtained, to obtain a personalized accurate search result. Search accuracy is improved, so that a waste of physical resources for implementing the search can be reduced, and utilization of the physical resources is improved.

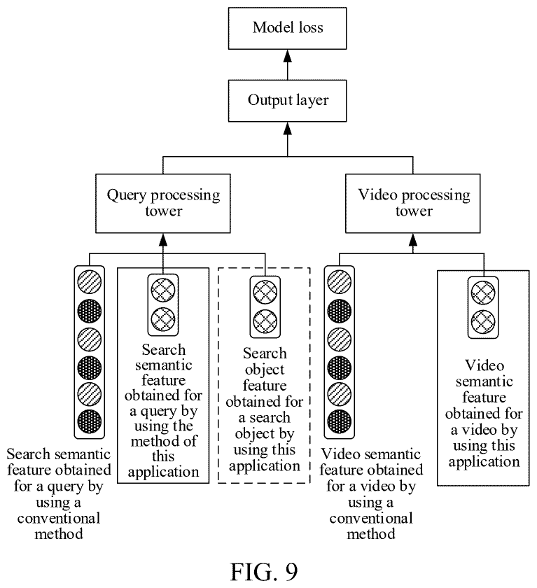

In an embodiment, a video is used as an example for describing a data processing process of the two-tower search model. As shown in FIG. 9, the two-tower search model includes a query processing tower and a video processing tower. The query processing tower is configured to process related information of a query, and the video processing tower is configured to process related information of a video. The two-tower search model is trained based on training data. For example, the training data includes a positive node pair and a negative node pair, the positive node pair includes feature embeddings respectively corresponding to a query and a video that match each other, and the negative node pair includes feature embeddings respectively corresponding to a query and a video that do not match each other. A sample pair is inputted to the two-tower search model to obtain a matching degree corresponding to the sample pair. A model loss is calculated based on matching degrees respectively corresponding to different sample pairs, and a model parameter of the two-tower search model is adjusted based on the model loss. The two-tower search model may be trained in various training modes suitable for the two-tower model.

A search semantic feature obtained for a query by using the method of the present disclosure and a video semantic feature obtained for a video by using the method of the present disclosure include more abundant information, and may be configured for improving model performance of a suitable two-tower search model. The search semantic feature obtained for the query by using the method of the present disclosure is used as supplementary input data for a query processing tower in the two-tower search model, and the video semantic feature obtained for the video by using the method of the present disclosure is used as supplementary input data for a video processing tower in the two-tower search model.

After training of the two-tower search model is completed, the two towers and an output layer may separately perform processing. A final feature embedding of a video may be pre-generated through offline inference by the video processing tower in the model and cached. During an online search, the video processing tower does not need to perform inference in real time, and the feature embedding of the video may be directly obtained from the cache. When a video search is triggered, a final feature embedding of a query is generated through real-time inference by the query processing tower. Finally, the final feature embedding of the query and final feature embeddings of plurality of candidate videos are separately transmitted to the output layer for scoring, to obtain scores of matching between the query and the candidate videos. The candidate videos are sorted in descending order of the matching scores, and a final search result is determined based on a sorting result.

As indicated by a dashed-line box in FIG. 9, in a personalization scenario, a search object feature obtained for a search object by using the method of the present disclosure may be further used as another piece of supplementary input data for the query processing tower in the conventional two-tower search model, so that the two-tower search model has a personalization capability.

In an embodiment, the determining, based on the first matching degree, the target search data from the candidate search data as the search result corresponding to the current search data includes:
determining intermediate search data from the candidate search data based on the first matching degree, and using a target semantic feature corresponding to the intermediate search data as an intermediate search feature; inputting the current search feature and the intermediate search feature to a one-tower search model, to obtain a second matching degree between the intermediate search data and the current search data; and determining, based on the second matching degree, target search data from the intermediate search data as the search result corresponding to the current search data.

The one-tower search model is a machine learning model in which data processing is uniformly performed. Input data for the one-tower search model includes target semantic features corresponding to different search data, and output data of the one-tower search model includes a matching degree between different search data.

The intermediate search data is search data to be further filtered. The second matching degree is a matching degree outputted by the one-tower search model.

Specifically, to further improve search accuracy, after candidate search data is preliminarily filtered by using the two-tower search model, filtered candidate search data may be further filtered by using the one-tower search model to obtain a final search result.

First, candidate search data is preliminarily filtered by using the two-tower search model. The computer device determines intermediate search data from different candidate search data based on the first matching degree outputted by the two-tower search model. For example, candidate search data with a first matching degree higher than a matching degree threshold is used as the intermediate search data; or sorting is performed in descending order of first matching degrees, and a preset quantity of pieces of candidate search data sorted in the front are used as the intermediate search data. Then, re-filtering is performed by using the one-tower search model. The computer device uses a target semantic feature corresponding to the intermediate search data as an intermediate search feature, and inputs the current search feature and the intermediate search feature to the one-tower search model. The one-tower search model performs full cross-fusion on the features to obtain a second matching degree between the intermediate search data and the current search data. The computer device determines, based on the second matching degree, target search data from the intermediate search data as the search result corresponding to the current search data. For example, a higher second matching degree indicates higher matching. At least one piece of intermediate search data with a highest second matching degree is obtained from a plurality of pieces of intermediate search data as the target search data, or intermediate search data with a second matching degree higher than a matching degree threshold is obtained from a plurality of pieces of intermediate search data as the target search data.

During a data search, candidate search data may alternatively be filtered by using the one-tower search model alone to obtain a search result.

In the foregoing embodiment, during a data search, a coarse search is first performed by using the two-tower search model, and then a fine search is performed by using the one-tower search model, to improve accuracy of a search result. Search accuracy is improved, so that a waste of physical resources for implementing the search can be reduced, and utilization of the physical resources is improved.

In an embodiment, the inputting the current search feature and the intermediate search feature to a one-tower search model, to obtain a second matching degree between the intermediate search data and the current search data includes:
inputting, to the one-tower search model, the current search feature, the intermediate search feature, and a feature similarity between the current search feature and the intermediate search feature, to obtain the second matching degree between the intermediate search data and the current search data.

Specifically, input data for the one-tower search model includes target semantic features corresponding to different search data and feature similarities between different target semantic features. The current search feature, the intermediate search feature, and the feature similarity between the current search feature and the intermediate search feature are inputted to the one-tower search model. The one-tower search model performs full cross-fusion on different input data to obtain the second matching degree between the intermediate search data and the current search data.

In the foregoing embodiment, during a search by using the one-tower search model, the feature similarity between the current search feature and the intermediate search feature is further inputted to the one-tower search model, to provide abundant input data for the one-tower search model, so that accuracy of a search result obtained through the search by using the one-tower search model is improved. Search accuracy is improved, so that a waste of physical resources for implementing the search can be reduced, and utilization of the physical resources is improved.

In an embodiment, the inputting, to the one-tower search model, the current search feature, the intermediate search feature, and a feature similarity between the current search feature and the intermediate search feature, to obtain the second matching degree between the intermediate search data and the current search data includes:
inputting, to the one-tower search model, the current search feature, the intermediate search feature, the feature similarity between the current search feature and the intermediate search feature, a target object feature corresponding to the current search object, and a feature similarity between the target object feature and the intermediate search feature, to obtain the second matching degree between the intermediate search data and the current search data.

Specifically, to improve matching between a search result and a user, in addition to the current search feature, the intermediate search feature, and the feature similarity between the current search feature and the intermediate search feature, the target object feature corresponding to the current search object and the feature similarity between the target object feature and the intermediate search feature may also be inputted to the one-tower search model, to obtain the second matching degree through data processing by the one-tower search model. The target object feature corresponding to the current search object and the feature similarity between the target object feature and the intermediate search feature are also inputted to the one-tower search model, and the one-tower search model further considers user preference information when outputting the second matching degree, so that a search result subsequently determined based on the second matching degree is personalized target search data for the user.

In the foregoing embodiment, during a search by using the one-tower search model, the target object feature corresponding to the current search object and the feature similarity between the target object feature and the intermediate search feature are further inputted to the one-tower search model, to provide abundant input data for the one-tower search model. In this way, a search result obtained through the search by using the one-tower search model further matches the search object, so that a personalized search is implemented. In addition, a waste of physical resources for implementing the search can be reduced, and utilization of the physical resources is improved.

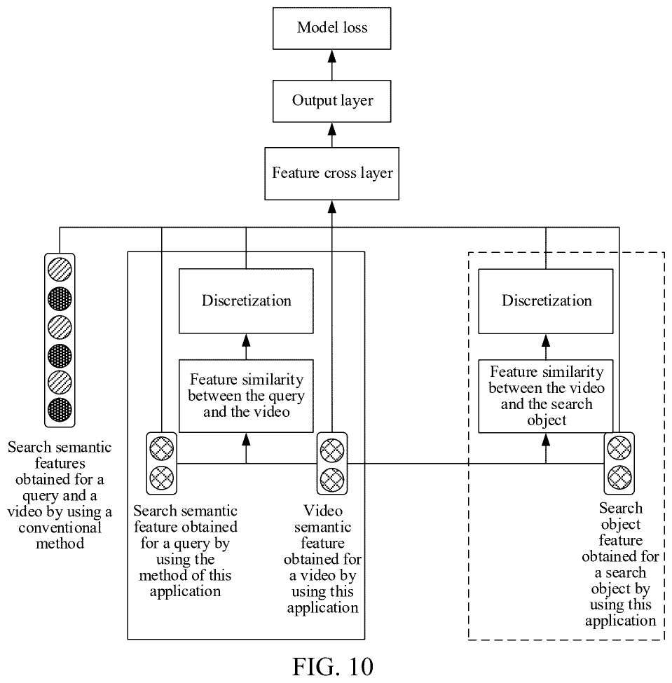

In an embodiment, a video is used as an example for describing a data processing process of the one-tower search model. As shown in FIG. 10, the one-tower search model includes a feature cross layer and an output layer that are sequentially connected. The feature cross layer is configured to perform cross-fusion on features, and the output layer is configured to calculate a matching degree between a query and a video based on data outputted by the feature cross layer. The one-tower search model is trained based on training data. The one-tower search model may be trained in various training modes suitable for the one-tower model. A search semantic feature obtained for a query by using the method of the present disclosure and a video semantic feature obtained for a video by using the method of the present disclosure include more abundant information, and may be configured for improving model performance of single conventional one-tower search model.

The search semantic feature obtained for the query by using the method of the present disclosure and the video semantic feature obtained for the video by using the method of the present disclosure are used as supplementary input data for the conventional one-tower search model. In addition, a feature similarity between the search semantic feature obtained for the query by using the method of the present disclosure and the video semantic feature obtained for the video by using the method of the present disclosure may be further calculated. To enhance a generalization capability of the feature similarity, discretization processing is performed on the feature similarity, and a processed feature similarity is used as another piece of supplementary input data for the conventional one-tower search model. In addition, as indicated by a dashed-line box in FIG. 10, in a personalization scenario, a search object feature obtained for a search object by using the method of the present disclosure may be further used as another piece of supplementary input data for the conventional one-tower search model, so that the one-tower search model has a personalization capability. A feature similarity between the search object feature obtained for the search object by using the method of the present disclosure and the video semantic feature obtained for the video by using the method of the present disclosure may be further calculated. To enhance a generalization capability of the feature similarity, discretization processing is performed on the feature similarity, and a processed feature similarity is used as another piece of supplementary input data for the conventional one-tower search model.

During application of the one-tower search model, final feature embeddings of related information of a query and candidate videos are generated through real-time inference by the feature cross layer in the model. Finally, the final feature embeddings are transmitted to the output layer for scoring, to obtain scores of matching between the query and the candidate videos. The candidate videos are sorted in descending order of the matching scores, and a final search result is determined based on a sorting result.

When a video search is triggered, candidate videos are first coarse-sorted by using the two-tower search model to obtain a preliminary search result, and then candidate videos in the preliminary search result are fine-sorted and re-sorted by using the one-tower search model to obtain a final search result.

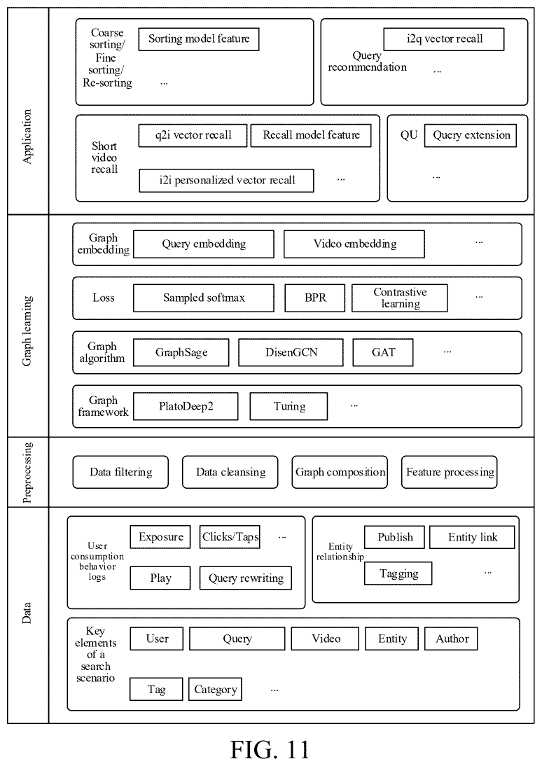

In a specific embodiment, FIG. 11 is a diagram of an overall architecture of a search data processing method according to the present disclosure. A video search graph is constructed by using the search data processing method of the present disclosure, and a graph neural network applied to a search task is trained based on the video search graph, to improve search accuracy. The overall architecture of the method of the present disclosure includes a data module, a preprocessing module, a graph learning module, and an application module.

The data module is configured to obtain raw data. A video search scenario is used as an example. Key elements in the video search scenario are obtained to construct nodes in a video search graph. For example, the key elements include a user u, a query (namely, query) q, a video v, a video author a, a query entity or video entity e, a query field category or video field category c, and a video tag t. Search consumption behavior logs of the user are obtained to construct an edge in the video search graph. For example, if the user clicks/taps or plays a video in a query, a connecting edge between the query and a node corresponding to the video is established. Entity relationship data is obtained to construct an edge in the video search graph. For example, a publish relationship (an ownership relationship between a video and an author of the video) is obtained, an entity link (an entity is mentioned in a query or a video) is obtained, and a tag (a tag added during video review and processing) is obtained.

The preprocessing module is configured to perform data preprocessing on the raw data. The preprocessing module includes a data filtering module, a data cleansing module, a graph composition module, and a feature processing module. For the data filtering module, in terms of search consumption behavior logs of a user, search logs in a “list page search” scenario (namely, a list-style search scenario) and an “immersive page search” scenario (namely, an immersive search scenario) are selected to construct a media search graph. For the data cleansing module, in terms of search logs, logs with key information missing are filtered out. For example, logs with the three core elements, namely, a user, a query, and a video, missing are filtered out, and logs with abnormal play duration are filtered out. In terms of entity relationship data, an entity with inaccurate entity recognition is removed, a field category with a few occurrences is removed, and a video author account system is normalized. For the graph composition module, the three core elements, namely, a user, a query, and a video, in logs are used as basic graph composition elements. If a user ux has searched for a query qy and positively consumed a video iz, the ux, qy, and iz nodes are added to graph composition, with a connecting edge between every two of the nodes. To ensure video coverage, a high-quality or fresh video that does not appear in positive consumption behavior logs is added. Author, entity, tag, and field category nodes associated with video and query nodes are added, and are connected to the corresponding video and query nodes through edges in the graph. Query change behavior data in search logs is mined, and adjacent queries that have a high text similarity and whose search time interval is within a specific interval are connected to each other through an edge in the graph. For the feature processing module, a feature of a node or an edge in the graph includes two types: an attribute feature and a statistical feature. For example, for a node or an edge resulting from search behavior logs, both features need to be added, and for a node or an edge resulting from another source, only an attribute feature needs to be added.

The graph learning module is configured to train a graph neural network. A graph framework for constructing the network may be a computing architecture such as PlatoDeep2 or Turing. A machine learning algorithm for constructing the network may be a graph algorithm such as GraphSage, DisenGCN, or GAT. A network loss calculation algorithm for the network may be a loss algorithm such as sampled softmax, Bayesian personalized ranking (BPR), or contrastive learning. The graph neural network may output a query embedding, a video embedding, and the like. For example, a plurality of meta-paths are designed for each q or i center node (namely, nodes corresponding to a query and a video). Each meta-path is a semantic interpretation of an associated center node, and different meta-paths correspond to different perspectives. Sub-graph sampling surrounding a center node is performed along directions of a plurality of meta-paths, and a plurality of sampling sub-graphs respectively corresponding all q and i center nodes are finally obtained. A sampling sub-graph corresponding to a center node is inputted to the graph neural network for feature aggregation to obtain a sub-graph embedding (namely, a sub-graph feature) corresponding to the center node. Sub-graph embeddings from a plurality of perspectives that correspond to the center node are fused to obtain a final embedding (namely, an initial semantic feature) of the center node.

A network loss of the graph neural network includes a node loss and a perspective loss. Joint training is performed based on the network loss by using a gradient descent method. A plurality of rounds of training are performed until convergence occurs. In a manner similar to the manner of generating a final embedding of a q or i center node during training, multi-perspective embeddings of a q or i center node are generated and fused by using a trained graph neural network, and results obtained through normalization are used as a final embedding of a query (namely, a target semantic feature of the query) and a final embedding of a video (namely, a target semantic feature of the video). For a personalized application scenario, a user preference needs to be modeled, final embeddings of N videos recently positively consumed by the user are averaged and normalized, and a processing result is used as a user embedding of the user.

In the search data processing method of the present disclosure, a search object behavior and a field entity association relationship that are related to a video search scenario are fully considered, and joint pre-training is performed by combining the supervised learning method based on search object behaviors and the contrastive learning method based on multi-perspective graphs, to learn more general information of the video search scenario.

The application module is configured to apply the trained graph neural network to various search-related tasks, to improve accuracy of a search result. Feature vectors (namely, target semantic features) respectively corresponding to a query and a video are extracted by using the graph neural network, and data is recalled based on the feature vectors. In addition, a feature vector corresponding to a user may be further extracted by using the graph neural network, and a user embedding of the user is further introduced to implement a personalized search during a data recall. The trained graph neural network may be applied to a query recommendation task. For example, during application in an i2q search scenario, a related query is recalled based on a video that is currently being positively consumed by a user, to recommend the related query to the user. The trained graph neural network may be applied to a short video recall task. For example, during application in a q2i search scenario, a related short video is recalled based on a current query of a user, to return a short video found based on the current query to the user. During application in an i2i search scenario, a related short video is recalled based on a short video that is currently being positively consumed by a user, to recommend the related short video to the user. A short video recall model may be used during a short video recall. A feature vector extracted by the graph neural network is used as an input feature for the short video recall model to improve accuracy of the short video recall model. The trained graph neural network may be applied to a query understanding (QU) task. For example, during application in a q2q search scenario, a related query is recalled based on a current query of a user, to recommend the related query to the user. In any search task, coarse sorting, fine sorting, and re-sorting may be performed on candidate data to obtain a final search result. A sorting model may be used during the coarse sorting, fine sorting, and re-sorting. A feature vector extracted by the graph neural network is used as an input feature for the sorting model to improve accuracy of the sorting model.

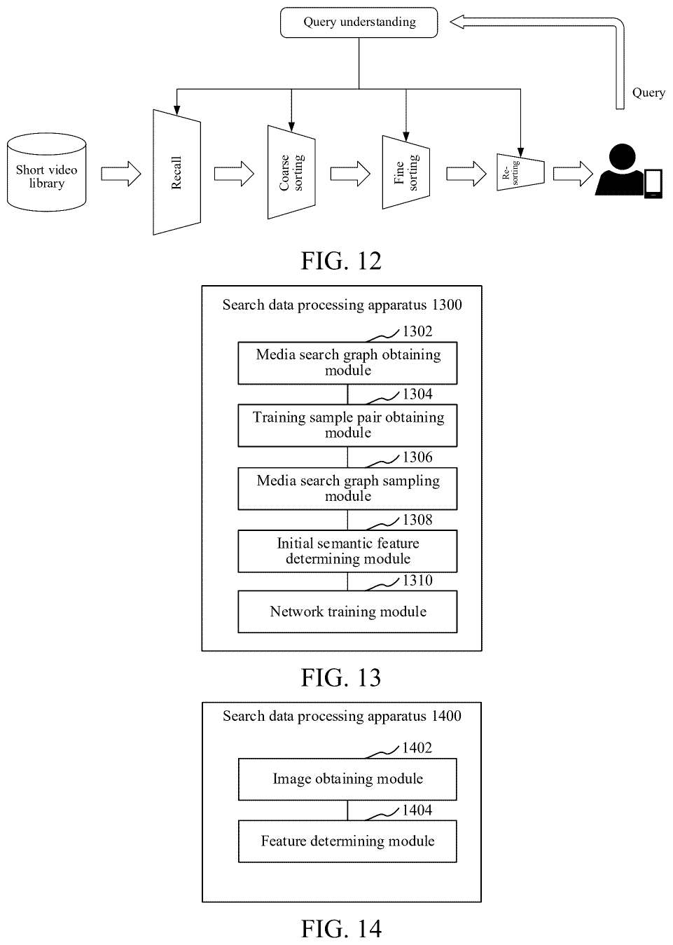

In a specific embodiment, the search data processing method of the present disclosure may be applied to a video search scenario. As shown in FIG. 12, in a q2i search scenario, after a user enters a query to initiate a video search, a QU module performs processing. In the QU module, processing is sequentially performed by a recall module, a coarse sorting module, a fine sorting module, and a re-sorting module to obtain a final search result to be displayed to the user. A target semantic feature extracted by using the method of the present disclosure may be configured for optimizing any module in the QU module. For example, a target semantic feature of a query or a video that is extracted by using the method of the present disclosure may be used as an input feature for a related model in the recall, coarse sorting, fine sorting, or re-sorting module, to supplement in-depth semantic and interaction information for the model and improve effect of the model. In the QU module, a target semantic feature of a query and target semantic features of candidate videos in a video library are extracted by using the method of the present disclosure. Candidate videos related to the query are recalled from the video library based on the target semantic features respectively corresponding to the query and the candidate videos. The recalled candidate videos are sequentially filtered by the coarse sorting module, the fine sorting module, and the re-sorting module to finally obtain several target videos as a search result for the query to be displayed to the user. For example, recalling is performed based on a feature similarity between the target semantic features of the query and the candidate videos, coarse sorting is performed based on the two-tower search model, fine sorting is performed based on the one-tower search model, and re-sorting is performed based on the one-tower search model. For another example, recalling is performed based on the search recall model, coarse sorting is performed based on the two-tower search model, fine sorting is performed based on the one-tower search model, and re-sorting is performed based on the one-tower search model. Input data for the search recall model includes the target semantic features of the query and the candidate videos.

For video searches, in addition to the q2i search scenario, the method may be further applied to a variety of search scenarios such as q2q, i2q, and i2i. In addition to videos, which are a type of media data, the search data processing method of the present disclosure may be applied to various search scenarios for other media data.

Further, when the recall module recalls a query or a video from a recall pool, regardless of whether a query or a video is to be recalled, queries or videos within a specific range usually need to be selected to create an index library. Factors considered as conditions for selection from a video library include video quality, freshness, a quantity of video views or a play completion rate in recent days, and the like. Factors considered as conditions for selection from a query library include a quantity of video views or a play completion rate in a query, and the like. After a query or video range is selected, a vector index may be established. Common vector index engines include Facebook AI Similarity Search (Faiss, an open source library developed by the Facebook AI team for clustering and similarity searches), Approximate Nearest Neighbor Oh Yeah (Annoy), and the like.

A video search scenario involves abundant information such as entities, elements, mutual relationships, and user interaction behaviors. In the method of the present disclosure, the information is sorted and is effectively integrated based on a “user-query-video” ternary relationship, and joint pre-training is performed by combining the supervised learning method based on search object behaviors and the contrastive learning method based on multi-perspective graphs to learn more abundant and general query and short video embeddings, to make up for shortage of signals in current algorithms for search scenarios.

Although the operations are shown sequentially according to the instructions of the arrows in the flowcharts of the foregoing embodiments, the operations are not necessarily performed sequentially according to the sequence instructed by the arrows. Unless otherwise explicitly specified in the present disclosure, an execution sequence of the operations is not strictly limited, and the operations may be performed in other sequences. Moreover, at least some of the operations in the flowcharts in the foregoing embodiments may include a plurality of operations or a plurality of stages. The operations or stages are not necessarily performed at the same moment but may be performed at different moments. The operations or stages are not necessarily performed sequentially, but may be performed alternately with other operations or at least some of operations or stages of other operations.

Based on same/similar inventive concepts, embodiments of the present disclosure further provide a search data processing apparatus for implementing the foregoing search data processing method. Implementation solutions provided by the apparatus for resolving problems are similar to the implementation solutions described in the foregoing method. Therefore, for specific limitations in one or more search data processing apparatus embodiments provided below, refer to the limitations on the search data processing method in the foregoing descriptions. Details are not described herein again.

In an embodiment, as shown in FIG. 13, a search data processing apparatus 1300 is provided, including a media search graph obtaining module 1302, a training sample pair obtaining module 1304, a media search graph sampling module 1306, an initial semantic feature determining module 1308, and a network training module 1310.

The media search graph obtaining module 1302 is configured to obtain a media search graph. The media search graph includes a query node corresponding to a query, a media node corresponding to media data, and an association node corresponding to association data, and the association data includes data associated with at least one of the query and the media data.

The training sample pair obtaining module 1304 is configured to obtain a plurality of first training sample pairs from the media search graph. The plurality of first training sample pairs include a positive node pair and a negative node pair. The positive node pair includes a query node and a media node that are connected to each other in the media search graph. The negative node pair includes a query node and a media node that are randomly combined in the media search graph.

The media search graph sampling module 1306 is configured to sample the media search graph based on meta-paths respectively corresponding to the query and the media data, to obtain sampling sub-graphs respectively corresponding to the query node and the media node in the first training sample pair. The meta-path is a sampling path starting from the query node or the media node in the media search graph.

The initial semantic feature determining module 1308 is configured to input, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair.

The network training module 1310 is configured to train the initial graph neural network based on a difference between semantic feature pairs respectively corresponding to the positive node pair and the negative node pair, to obtain a target graph neural network. The target graph neural network is configured to determine a target semantic feature corresponding to a query node or a media node.

In an embodiment, the media search graph obtaining module 1302 is further configured to:
obtain historical search information corresponding to a plurality of search objects, the historical search information including a historical query and positive media data corresponding to the historical query, and the positive media data being media data corresponding to a positive feedback by the search object; generate an object node corresponding to each search object, a query node corresponding to each historical query, and a media node corresponding to each piece of positive media data, establish a connection relationship between the object node and a corresponding query node, establish a connection relationship between the object node and a corresponding media node, and establish a connection relationship between the query node and a corresponding media node; obtain at least one type of association data corresponding to each of the historical query and the positive media data, the at least one type of association data including an associated entity, an associated tag, an associated category, or an associated publish object; generate an association node corresponding to each piece of association data, establish a connection relationship between the query node and a corresponding association node, and establish a connection relationship between the media node and a corresponding association node; obtain a node feature corresponding to each node and a connection feature corresponding to each connection relationship; and generate the media search graph based on each node, the node feature corresponding to the node, a connection relationship between nodes, and a connection feature corresponding to the connection relationship.

In an embodiment, the media search graph obtaining module 1302 is further configured to:
obtain supplementary media data, and generate a media node corresponding to the supplementary media data, the supplementary media data including at least one of first media data and second media data, the first media data being media data with media quality higher than a quality threshold, and the second media data being media data with a time interval between publish time and current time less than a first time interval threshold; and obtain at least one type of association data corresponding to the supplementary media data.

In an embodiment, the media search graph obtaining module 1302 is further configured to:
obtain a rewritten query corresponding to the historical query; when a search time interval between the historical query and the corresponding rewritten query is less than a second time interval threshold and a similarity between the historical query and the corresponding rewritten query is greater than a similarity threshold, generate a query node corresponding to the rewritten query; and establish a connection relationship between the query node corresponding to the historical query and the query node corresponding to the rewritten query.

In an embodiment, the media search graph sampling module 1306 is further configured to:
determine a current search meta-path from at least one meta-path corresponding to the query, the current search meta-path being a path formed by sequentially connecting type flags respectively corresponding to a search type, a first type, and a second type; and sample, by using a current query node as a search center node, at least two nodes that are directly connected to the search center node and that belong to the first type from the media search graph as a first-order neighbor node corresponding to the search center node, sample at least two nodes that are directly connected to the first-order neighbor node and that belong to the second type from the media search graph as a second-order neighbor node corresponding to the search center node, and obtain a sampling sub-graph corresponding to the search center node in the current search meta-path based on the search center node and the corresponding first neighbor node second neighbor node; and
determine a current media meta-path from at least one meta-path corresponding to the media data, the current media meta-path being a path formed by sequentially connecting type flags respectively corresponding to a media type, a third type, and a fourth type; and sample, by using a current media node as a center media node, at least two nodes that are directly connected to the center media node and that belong to the third type from the media search graph as a first-order neighbor node corresponding to the center media node, sample at least two nodes that are directly connected to the first-order neighbor node and that belong to the fourth type from the media search graph as a second-order neighbor node corresponding to the center media node, and obtain a sampling sub-graph corresponding to the center media node in the current media meta-path based on the center media node and the corresponding first neighbor node second neighbor node.

In an embodiment, a current node is a query node or a media node, and the initial semantic feature determining module 1308 is further configured to:
input, to the initial graph neural network, sampling sub-graphs from at least two perspectives that correspond to the current node, to obtain respective sub-graph features of the sampling sub-graphs corresponding to the current node, the current node being the query node or the media node in the first training sample pair, and different meta-paths corresponding to different semantic perspectives; and fuse the sub-graph features corresponding to the current node, to obtain an initial semantic feature corresponding to the current node.

In an embodiment, a sampling sub-graph corresponding to a node includes the node and a first-order neighbor node and a second-order neighbor node that correspond to the node, and the initial semantic feature determining module 1308 is further configured to:
aggregate, to a first-order neighbor node by using the initial graph neural network, a node feature corresponding to a second-order neighbor node in a current sampling sub-graph corresponding to the current node, and a connection feature between the second-order neighbor node and the first-order neighbor node, to obtain a second-order aggregated feature corresponding to the first-order neighbor node; aggregate, to the current node by using the initial graph neural network, a node feature corresponding to the first-order neighbor node, the second-order aggregated feature, and a connection feature between the first-order neighbor node and the current node, to obtain a first-order aggregated feature corresponding to the current node; and obtain, by using the initial graph neural network based on the node feature corresponding to the current node and the first-order aggregated feature, a sub-graph feature of the current sampling sub-graph corresponding to the current node.

In an embodiment, the network training module 1310 is further configured to:
obtain a node loss based on the difference between the semantic feature pairs respectively corresponding to the positive node pair and the negative node pair; obtain a second training sample pair, the second training sample pair including a positive sampling sub-graph pair and a negative sampling sub-graph pair, the positive sampling sub-graph pair including sampling sub-graphs from different semantic perspectives that correspond to a same node, and the negative sampling sub-graph pair including sampling sub-graphs corresponding to different nodes; input each sampling sub-graph in the second training sample pair to the initial graph neural network, to obtain a sub-graph feature of each sampling sub-graph in the second training sample pair, and form a sub-graph feature pair corresponding to the second training sample pair; obtain a perspective loss based on a difference between sub-graph feature pairs respectively corresponding to the positive sampling sub-graph pair and the negative sampling sub-graph pair; and train the initial graph neural network based on the node loss and the perspective loss to obtain the target graph neural network.

In an embodiment, the network training module 1310 is further configured to:
obtain, based on a feature similarity between initial semantic features in a same semantic feature pair, a semantic similarity corresponding to the semantic feature pair; fuse semantic similarities respectively corresponding to a same positive node pair and corresponding negative node pairs, to obtain a fusion similarity corresponding to the positive node pair, a negative node pair corresponding to the positive node pair being a negative node pair having an overlapping node with the positive node pair; obtain, based on a difference between a semantic similarity and a fusion similarity that correspond to a same positive node pair, a node sub-loss corresponding to the positive node pair; and obtain the node loss based on a node sub-loss corresponding to each positive node pair.

In an embodiment, the network training module 1310 is further configured to:
obtain, based on a feature similarity between sub-graph features in a same sub-graph feature pair, a perspective similarity corresponding to the sub-graph feature pair; fuse perspective similarities respectively corresponding to a same positive sampling sub-graph pair and corresponding negative sampling sub-graph pairs, to obtain a fusion similarity corresponding to the positive sampling sub-graph pair; obtain, based on a difference between a perspective similarity and a fusion similarity that correspond to a same positive sampling sub-graph pair, a perspective sub-loss corresponding to the positive sampling sub-graph pair; and obtain the perspective loss based on a perspective sub-loss corresponding to each positive sampling sub-graph pair.

In the foregoing search data processing apparatus, the media search graph includes not only a query node and a media node, but also an association node. The media search graph includes abundant information. Further, the media search graph is sampled based on a meta-path corresponding to a corresponding node, to obtain a sampling sub-graph corresponding to the corresponding node. The sampling sub-graph also includes abundant information. This helps improve accuracy of subsequent feature extraction. A sampling sub-graph corresponding to a node may be inputted to the target graph neural network obtained through training for feature extraction, to obtain a target semantic feature corresponding to the node. The target semantic feature includes node information corresponding to nodes in the sampling sub-graph, and therefore has high accuracy. This can also effectively improve accuracy of a subsequent search. In addition, during training of the graph neural network, a positive node pair includes a query node and a media node that are associated, and a negative node pair includes a query node and a media node that are unassociated. The graph neural network is trained based on a difference between semantic feature pairs respectively corresponding to the positive node pair and the negative node pair, so that accuracy of the graph neural network in feature extraction can be improved. Therefore, the graph neural network outputs similar semantic features for a query node and a media node that are associated, and outputs dissimilar semantic features for a query node and a media node that are unassociated. In this way, accuracy of a subsequent search based on a semantic feature can also be effectively improved.

In an embodiment, as shown in FIG. 14, a search data processing apparatus 1400 is provided, including an image obtaining module 1402 and a feature determining module 1404.

The image obtaining module 1402 is configured to obtain a sampling sub-graph corresponding to a target node. The target node includes at least one of a query node and a media node. The sampling sub-graph corresponding to the target node is obtained by sampling a media search graph.

The feature determining module 1404 is configured to input, to a target graph neural network, the sampling sub-graph corresponding to the target node, to obtain a target semantic feature corresponding to the target node. The target semantic feature is used for a data search.

For a training process for the target graph neural network, refer to the content of the foregoing embodiments. Details are not described herein again.

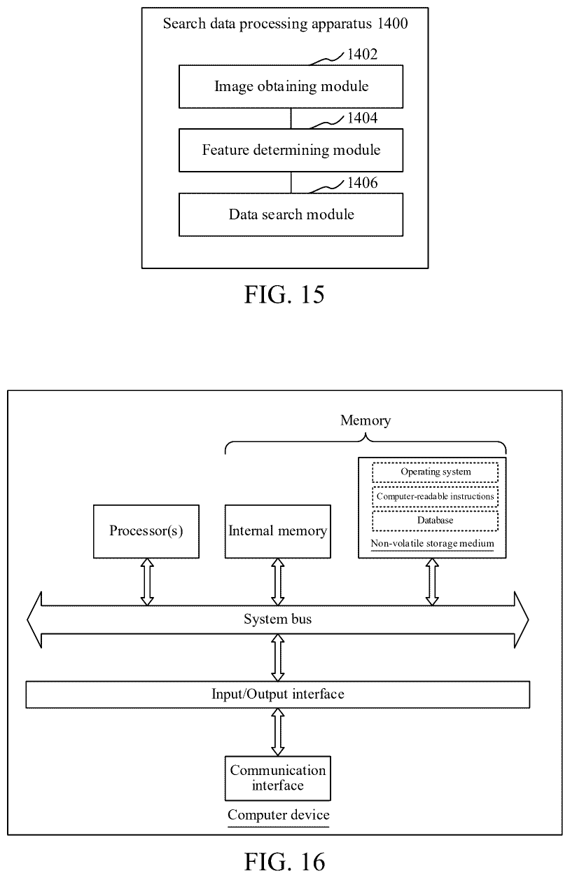

In an embodiment, as shown in FIG. 15, the search data processing apparatus 1400 further includes a data search module 1406, and the data search module 1406 is further configured to:
obtain a target semantic feature corresponding to current search data of a current search object as a current search feature, and obtain a target semantic feature corresponding to candidate search data as a candidate search feature, the current search data being a current query or current media data, and the candidate search data being a candidate query or candidate media data; and determine, based on a feature similarity between the current search feature and the candidate search feature, target search data from a plurality of pieces of candidate search data as a search result corresponding to the current search data.

In an embodiment, the data search module 1406 is further configured to:
obtain target semantic features respectively corresponding to at least two pieces of positive media data corresponding to the current search object; fuse the target semantic features respectively corresponding to the at least two pieces of positive media data, to obtain a target object feature corresponding to the current search object; fuse the target object feature and the current search feature to obtain a fusion search feature; and determine, based on a feature similarity between the fusion search feature and the candidate search feature, target search data from a plurality of pieces of candidate search data as a search result corresponding to the current search data.

In an embodiment, the data search module 1406 is further configured to:
input, to a first processing branch in a two-tower search model, a candidate search feature corresponding to each piece of candidate search data, to obtain a first search feature corresponding to the candidate search data; input the current search feature to a second processing branch in the two-tower search model, to obtain a second search feature; input the first search feature and the second search feature to an output layer in the two-tower search model, to obtain a first matching degree between each piece of candidate search data and the current search data; and determine, based on the first matching degree, the target search data from the candidate search data as the search result corresponding to the current search data.

In an embodiment, the data search module 1406 is further configured to:
input, to the second processing branch in the two-tower search model, the target object feature corresponding to the current search object and the current search feature, to obtain the second search feature.

In an embodiment, the data search module 1406 is further configured to:
determine intermediate search data from the candidate search data based on the first matching degree, and using a target semantic feature corresponding to the intermediate search data as an intermediate search feature; input the current search feature and the intermediate search feature to a one-tower search model, to obtain a second matching degree between the intermediate search data and the current search data; and determine, based on the second matching degree, target search data from the intermediate search data as the search result corresponding to the current search data.

In an embodiment, the data search module 1406 is further configured to:
input, to the one-tower search model, the current search feature, the intermediate search feature, and a feature similarity between the current search feature and the intermediate search feature, to obtain the second matching degree between the intermediate search data and the current search data.

In an embodiment, the data search module 1406 is further configured to:
input, to the one-tower search model, the current search feature, the intermediate search feature, the feature similarity between the current search feature and the intermediate search feature, a target object feature corresponding to the current search object, and a feature similarity between the target object feature and the intermediate search feature, to obtain the second matching degree between the intermediate search data and the current search data.

In the foregoing search data processing apparatus, a training sample pair for a graph neural network includes a positive node pair and a negative node pair. The positive node pair includes a query node and a media node that are connected to each other in the media search graph. The negative node pair includes a query node and a media node that are randomly combined in the media search graph. The media search graph includes not only a query node and a media node, but also an association node. The media search graph includes abundant information. Further, the media search graph is sampled based on a meta-path corresponding to a corresponding node, to obtain a sampling sub-graph corresponding to the corresponding node. The sampling sub-graph also includes abundant information. This helps improve accuracy of subsequent feature extraction. During training of the graph neural network, a positive node pair includes a query node and a media node that are associated, and a negative node pair includes a query node and a media node that are unassociated. The graph neural network is trained based on a difference between semantic feature pairs respectively corresponding to the positive node pair and the negative node pair, so that accuracy of the graph neural network in feature extraction can be improved. Therefore, the graph neural network outputs similar semantic features for a query node and a media node that are associated, and outputs dissimilar semantic features for a query node and a media node that are unassociated. In this way, accuracy of a subsequent search based on a semantic feature can also be effectively improved. A sampling sub-graph corresponding to a node may be inputted to the target graph neural network obtained through training for feature extraction, to obtain a target semantic feature corresponding to the node. The target semantic feature includes node information corresponding to nodes in the sampling sub-graph, and therefore has high accuracy. This can also effectively improve accuracy of a subsequent search.

All or some of the modules in the search data processing apparatus may be implemented by software, hardware, and a combination thereof. The foregoing modules may be embedded in or independent of a processor of a computer device in a form of hardware, or may be stored in a memory of a computer device in a form of software, so that the processor can invoke the modules to perform operations corresponding to the modules.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

In an embodiment, a computer device is provided. The computer device may be a server, and a diagram of an internal structure of the computer device may be shown in FIG. 16. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium has an operating system, computer-readable instructions, and a database stored therein. The internal memory provides an operating environment for the operating system and the computer-readable instructions in the non-volatile storage medium. The database of the computer device is configured to store media search graphs, graph neural networks, and other data. The input/output interface of the computer device is configured to exchange information between the processor and an external device. The communication interface of the computer device is configured to communicate with an external terminal through a network. The computer-readable instructions are executed by the processor to implement a search data processing method.

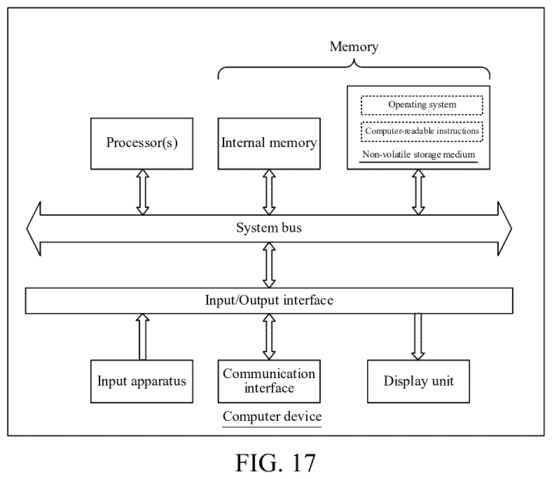

In an embodiment, a computer device is provided. The computer device may be a terminal, and a diagram of an internal structure of the computer device may be shown in FIG. 17. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium stores an operating system and computer-readable instructions. The internal memory provides an operating environment for the operating system and the computer-readable instructions in the non-volatile storage medium. The input/output interface of the computer device is configured to exchange information between the processor and an external device. The communication interface of the computer device is configured for wired or wireless communication with an external terminal. A wireless mode may be implemented through Wi-Fi, a mobile cellular network, near field communication (NFC), or other technologies. The computer-readable instructions are executed by the processor to implement a search data processing method. The display unit of the computer device is configured to form a visible picture, and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, mouse, or the like.

A person skilled in the art can understand that the structures shown in FIG. 16 and FIG. 17 are merely block diagrams of partial structures related to the solutions in the present disclosure, and do not constitute a limitation to the computer device to which the solutions in the present disclosure are applied. Specifically, the computer device may include more or fewer components than those shown in the figure, or some components may be combined, or a different component layout may be used.

In an embodiment, a computer device is further provided, including a memory and a processor. The memory has computer-readable instructions stored therein. The processor, when executing the computer-readable instructions, implements the operations in the foregoing method embodiments.

In an embodiment, a computer-readable storage medium is provided, having computer-readable instructions stored therein. When the computer-readable instructions are executed by a processor, the operations in the foregoing method embodiments are implemented.

In an embodiment, a computer program product is provided. The computer program product includes computer-readable instructions. When the computer-readable instructions are executed by a processor, the operations in the foregoing method embodiments are implemented.

User information (including but not limited to user equipment information, personal information of users, and the like) and data (including but not limited to data for analysis, stored data, displayed data, and the like) in the present disclosure are information and data used under authorization by users or full authorization by all parties. In addition, collection, use, and processing of related data need to comply with related laws, regulations, and standards in related countries and regions.

A person of ordinary skill in the art can understand that all or some of the processes of the methods in the foregoing embodiments may be implemented by computer-readable instructions instructing relevant hardware. The computer-readable instructions may be stored in a non-volatile computer-readable storage medium. When the computer-readable instructions are executed, the processes in the foregoing method embodiments may be implemented. Any reference to a memory, a database, or other media used in the embodiments provided in the present disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache memory, or the like. For illustration rather than limitation, the RAM may have a plurality of forms, for example, a static random access memory (SRAM) or a dynamic random access memory (DRAM). The database in the embodiments provided in the present disclosure may include at least one of a relational database and a non-relational database. The non-relational database may include but is not limited to a blockchain-based distributed database and the like. The processor in the embodiments provided in the present disclosure may be but is not limited to a general-purpose processor, a central processing unit, a graphics processing unit, a digital signal processor, a programmable logic device, a data processing logic device based on quantum computing, and the like.

Technical features of the foregoing embodiments may be combined in any manners. To make description concise, not all possible combinations of the technical features in the foregoing embodiments are described. However, the combinations of these technical features shall be considered as falling within the scope recorded by this specification provided that no conflict exists.

The foregoing embodiments merely describe several implementations of the present disclosure more specifically and in more detail, but cannot be understood as a limitation to the patent scope of the present disclosure. A person of ordinary skill in the art may also make several variations and improvements without departing from the concept of the present disclosure. All these variations and improvements fall within the protection scope of the present disclosure. Therefore, the protection scope of the present disclosure shall be subject to the appended claims.

What is claimed is:

1. A search data processing method, performed by a computer device, the method comprising:
obtaining a media search graph, the media search graph comprising a query node corresponding to a query, a media node corresponding to media data, and an association node corresponding to association data, and the association data comprising data associated with at least one of the query or the media data;
obtaining a plurality of first training sample pairs from the media search graph, the plurality of first training sample pairs comprising a positive node pair and a negative node pair, the positive node pair comprising a query node and a media node that are connected to each other in the media search graph, and the negative node pair comprising a query node and a media node that are randomly combined in the media search graph;
sampling the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph;
inputting, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair; and
training the initial graph neural network based on a difference between semantic feature pairs corresponding to the positive node pair and the negative node pair, to obtain a target graph neural network, the target graph neural network being configured to determine a target semantic feature corresponding to a query node or a media node.

2. The method according to claim 1, wherein obtaining the media search graph comprises:
obtaining historical search information corresponding to a plurality of search objects, the historical search information comprising a historical query and positive media data corresponding to the historical query, and the positive media data being media data corresponding to a positive feedback by the search object;
generating an object node corresponding to a search object of the plurality of search objects, a query node corresponding to a historical query, and a media node corresponding to a piece of positive media data, establishing a connection relationship between the object node and a corresponding query node, establishing a connection relationship between the object node and a corresponding media node, and establishing a connection relationship between the query node and a corresponding media node;
obtaining at least one type of association data corresponding to each of the historical query and the positive media data, the at least one type of association data comprising an associated entity, an associated tag, an associated category, or an associated publish object;
generating an association node corresponding to a piece of association data, establishing a connection relationship between the query node and a corresponding association node, and establishing a connection relationship between the media node and a corresponding association node;
obtaining a node feature corresponding to each node and a connection feature corresponding to each connection relationship; and
generating the media search graph based on the node, the node feature corresponding to the node, a connection relationship between nodes, and a connection feature corresponding to the connection relationship.

3. The method according to claim 2, further comprising:
obtaining supplementary media data, and generating a media node corresponding to the supplementary media data, the supplementary media data comprising at least one of first media data and second media data, the first media data being media data with media quality higher than a quality threshold, and the second media data being media data with a time interval between publish time and current time less than a first time interval threshold; and
obtaining at least one type of association data corresponding to the supplementary media data.

4. The method according to claim 2, further comprising:
obtaining a rewritten query corresponding to the historical query;
when a search time interval between the historical query and the corresponding rewritten query is less than a second time interval threshold and a similarity between the historical query and the corresponding rewritten query is greater than a similarity threshold, generating a query node corresponding to the rewritten query; and
establishing a connection relationship between the query node corresponding to the historical query and the query node corresponding to the rewritten query.

5. The method according to claim 1, wherein sampling the media search graph based on the meta-paths respectively corresponding to the query and the media data comprises:
determining a current search meta-path from at least one meta-path corresponding to the query, the current search meta-path being a path formed by sequentially connecting type flags respectively corresponding to a search type, a first type, and a second type;
sampling, by using a current query node as a search center node, at least two nodes that are directly connected to the search center node and that belong to the first type from the media search graph as a first-order neighbor node corresponding to the search center node, sampling at least two nodes that are directly connected to the first-order neighbor node and that belong to the second type from the media search graph as a second-order neighbor node corresponding to the search center node, and obtaining a sampling sub-graph corresponding to the search center node in the current search meta-path based on the search center node and the corresponding first neighbor node second neighbor node;
determining a current media meta-path from at least one meta-path corresponding to the media data, the current media meta-path being a path formed by sequentially connecting type flags respectively corresponding to a media type, a third type, and a fourth type; and
sampling, by using a current media node as a center media node, at least two nodes that are directly connected to the center media node and that belong to the third type from the media search graph as a first-order neighbor node corresponding to the center media node, sampling at least two nodes that are directly connected to the first-order neighbor node and that belong to the fourth type from the media search graph as a second-order neighbor node corresponding to the center media node, and obtaining a sampling sub-graph corresponding to the center media node in the current media meta-path based on the center media node and the corresponding first neighbor node second neighbor node.

6. The method according to claim 1, wherein inputting, to the initial graph neural network, the sampling sub-graphs respectively corresponding to the query node and the media node in the first training sample pair comprises:
inputting, to the initial graph neural network, sampling sub-graphs from at least two semantic perspectives that correspond to a current node, to obtain respective sub-graph features of the sampling sub-graphs corresponding to the current node, the current node being the query node or the media node in the first training sample pair, and different meta-paths corresponding to different semantic perspectives; and
fusing the sub-graph features corresponding to the current node, to obtain an initial semantic feature corresponding to the current node.

7. The method according to claim 6, wherein a sampling sub-graph corresponding to a node comprises the node and a first-order neighbor node and a second-order neighbor node that correspond to the node, and inputting, to the initial graph neural network, the sampling sub-graphs from the at least two semantic perspectives that correspond to the current node comprises:
aggregating, to a first-order neighbor node by using the initial graph neural network, a node feature corresponding to a second-order neighbor node in a current sampling sub-graph corresponding to the current node, and a connection feature between the second-order neighbor node and the first-order neighbor node, to obtain a second-order aggregated feature corresponding to the first-order neighbor node;
aggregating, to the current node by using the initial graph neural network, a node feature corresponding to the first-order neighbor node, the second-order aggregated feature, and a connection feature between the first-order neighbor node and the current node, to obtain a first-order aggregated feature corresponding to the current node; and
obtaining, by using the initial graph neural network based on the node feature corresponding to the current node and the first-order aggregated feature, a sub-graph feature of the current sampling sub-graph corresponding to the current node.

8. The method according to claim 1, wherein training the initial graph neural network based on the difference between semantic feature pairs corresponding to the positive node pair and the negative node pair, to obtain a target graph neural network comprises:
obtaining a node loss based on the difference between the semantic feature pairs corresponding to the positive node pair and the negative node pair;
obtaining a plurality of second training sample pairs, the plurality of second training sample pairs comprising a positive sampling sub-graph pair and a negative sampling sub-graph pair, the positive sampling sub-graph pair comprising sampling sub-graphs from different semantic perspectives that correspond to a same node, and the negative sampling sub-graph pair comprising sampling sub-graphs corresponding to different nodes that belong to a same type;
inputting each sampling sub-graph in the second training sample pair to the initial graph neural network, to obtain a sub-graph feature of each sampling sub-graph in the second training sample pair, and form a sub-graph feature pair corresponding to the second training sample pair;
obtaining a perspective loss based on a difference between sub-graph feature pairs corresponding to the positive sampling sub-graph pair and the negative sampling sub-graph pair; and
training the initial graph neural network based on the node loss and the perspective loss to obtain the target graph neural network.

9. The method according to claim 8, wherein obtaining the node loss based on the difference between the semantic feature pairs corresponding to the positive node pair and the negative node pair comprises:
obtaining, based on a feature similarity between initial semantic features in a same semantic feature pair, a semantic similarity corresponding to the semantic feature pair;
fusing semantic similarities respectively corresponding to a same positive node pair and corresponding negative node pairs, to obtain a fusion similarity corresponding to the positive node pair, a negative node pair corresponding to the positive node pair being a negative node pair having an overlapping node with the positive node pair;
obtaining, based on a difference between a semantic similarity and a fusion similarity that correspond to a same positive node pair, a node sub-loss corresponding to the positive node pair; and
obtaining the node loss based on a node sub-loss corresponding to each positive node pair.

10. The method according to claim 8, wherein obtaining the perspective loss based on the difference between sub-graph feature pairs corresponding to the positive sampling sub-graph pair and the negative sampling sub-graph pair comprises:
obtaining, based on a feature similarity between sub-graph features in a same sub-graph feature pair, a perspective similarity corresponding to the sub-graph feature pair;
fusing perspective similarities respectively corresponding to a same positive sampling sub-graph pair and corresponding negative sampling sub-graph pairs, to obtain a fusion similarity corresponding to the positive sampling sub-graph pair;
obtaining, based on a difference between a perspective similarity and a fusion similarity that correspond to a same positive sampling sub-graph pair, a perspective sub-loss corresponding to the positive sampling sub-graph pair; and
obtaining the perspective loss based on a perspective sub-loss corresponding to each positive sampling sub-graph pair.

11. A computer device, comprising
a memory and one or more processors, the memory containing computer-readable instructions that, when being executed, cause the one or more processors to perform:
obtaining a media search graph, the media search graph comprising a query node corresponding to a query, a media node corresponding to media data, and an association node corresponding to association data, and the association data comprising data associated with at least one of the query or the media data;
obtaining a plurality of first training sample pairs from the media search graph, the plurality of first training sample pairs comprising a positive node pair and a negative node pair, the positive node pair comprising a query node and a media node that are connected to each other in the media search graph, and the negative node pair comprising a query node and a media node that are randomly combined in the media search graph;
sampling the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph;
inputting, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair; and
training the initial graph neural network based on a difference between semantic feature pairs corresponding to the positive node pair and the negative node pair, to obtain a target graph neural network, the target graph neural network being configured to determine a target semantic feature corresponding to a query node or a media node.

12. The device according to claim 11, wherein the one or more processors are further configured to perform:
obtaining historical search information corresponding to a plurality of search objects, the historical search information comprising a historical query and positive media data corresponding to the historical query, and the positive media data being media data corresponding to a positive feedback by the search object;
generating an object node corresponding to a search object of the plurality of search objects, a query node corresponding to a historical query, and a media node corresponding to a piece of positive media data, establishing a connection relationship between the object node and a corresponding query node, establishing a connection relationship between the object node and a corresponding media node, and establishing a connection relationship between the query node and a corresponding media node;
obtaining at least one type of association data corresponding to each of the historical query and the positive media data, the at least one type of association data comprising an associated entity, an associated tag, an associated category, or an associated publish object;
generating an association node corresponding to a piece of association data, establishing a connection relationship between the query node and a corresponding association node, and establishing a connection relationship between the media node and a corresponding association node;
obtaining a node feature corresponding to each node and a connection feature corresponding to each connection relationship; and
generating the media search graph based on the node, the node feature corresponding to the node, a connection relationship between nodes, and a connection feature corresponding to the connection relationship.

13. The device according to claim 12, wherein the one or more processors are further configured to perform:
obtaining supplementary media data, and generating a media node corresponding to the supplementary media data, the supplementary media data comprising at least one of first media data and second media data, the first media data being media data with media quality higher than a quality threshold, and the second media data being media data with a time interval between publish time and current time less than a first time interval threshold; and
obtaining at least one type of association data corresponding to the supplementary media data.

14. The device according to claim 12, wherein the one or more processors are further configured to perform:
obtaining a rewritten query corresponding to the historical query;
when a search time interval between the historical query and the corresponding rewritten query is less than a second time interval threshold and a similarity between the historical query and the corresponding rewritten query is greater than a similarity threshold, generating a query node corresponding to the rewritten query; and
establishing a connection relationship between the query node corresponding to the historical query and the query node corresponding to the rewritten query.

15. The device according to claim 11, wherein the one or more processors are further configured to perform:
determining a current search meta-path from at least one meta-path corresponding to the query, the current search meta-path being a path formed by sequentially connecting type flags respectively corresponding to a search type, a first type, and a second type;
sampling, by using a current query node as a search center node, at least two nodes that are directly connected to the search center node and that belong to the first type from the media search graph as a first-order neighbor node corresponding to the search center node, sampling at least two nodes that are directly connected to the first-order neighbor node and that belong to the second type from the media search graph as a second-order neighbor node corresponding to the search center node, and obtaining a sampling sub-graph corresponding to the search center node in the current search meta-path based on the search center node and the corresponding first neighbor node second neighbor node;
determining a current media meta-path from at least one meta-path corresponding to the media data, the current media meta-path being a path formed by sequentially connecting type flags respectively corresponding to a media type, a third type, and a fourth type; and
sampling, by using a current media node as a center media node, at least two nodes that are directly connected to the center media node and that belong to the third type from the media search graph as a first-order neighbor node corresponding to the center media node, sampling at least two nodes that are directly connected to the first-order neighbor node and that belong to the fourth type from the media search graph as a second-order neighbor node corresponding to the center media node, and obtaining a sampling sub-graph corresponding to the center media node in the current media meta-path based on the center media node and the corresponding first neighbor node second neighbor node.

16. The device according to claim 11, wherein the one or more processors are further configured to perform:
inputting, to the initial graph neural network, sampling sub-graphs from at least two semantic perspectives that correspond to a current node, to obtain respective sub-graph features of the sampling sub-graphs corresponding to the current node, the current node being the query node or the media node in the first training sample pair, and different meta-paths corresponding to different semantic perspectives; and
fusing the sub-graph features corresponding to the current node, to obtain an initial semantic feature corresponding to the current node.

17. The device according to claim 16, wherein a sampling sub-graph corresponding to a node comprises the node and a first-order neighbor node and a second-order neighbor node that correspond to the node, and the one or more processors are further configured to perform:
aggregating, to a first-order neighbor node by using the initial graph neural network, a node feature corresponding to a second-order neighbor node in a current sampling sub-graph corresponding to the current node, and a connection feature between the second-order neighbor node and the first-order neighbor node, to obtain a second-order aggregated feature corresponding to the first-order neighbor node;
aggregating, to the current node by using the initial graph neural network, a node feature corresponding to the first-order neighbor node, the second-order aggregated feature, and a connection feature between the first-order neighbor node and the current node, to obtain a first-order aggregated feature corresponding to the current node; and
obtaining, by using the initial graph neural network based on the node feature corresponding to the current node and the first-order aggregated feature, a sub-graph feature of the current sampling sub-graph corresponding to the current node.

18. The device according to claim 11, wherein the one or more processors are further configured to perform:
obtaining a node loss based on the difference between the semantic feature pairs corresponding to the positive node pair and the negative node pair;
obtaining a plurality of second training sample pairs, the plurality of second training sample pairs comprising a positive sampling sub-graph pair and a negative sampling sub-graph pair, the positive sampling sub-graph pair comprising sampling sub-graphs from different semantic perspectives that correspond to a same node, and the negative sampling sub-graph pair comprising sampling sub-graphs corresponding to different nodes that belong to a same type;
inputting each sampling sub-graph in the second training sample pair to the initial graph neural network, to obtain a sub-graph feature of each sampling sub-graph in the second training sample pair, and form a sub-graph feature pair corresponding to the second training sample pair;
obtaining a perspective loss based on a difference between sub-graph feature pairs corresponding to the positive sampling sub-graph pair and the negative sampling sub-graph pair; and
training the initial graph neural network based on the node loss and the perspective loss to obtain the target graph neural network.

19. The device according to claim 18, wherein the one or more processors are further configured to perform:
obtaining, based on a feature similarity between initial semantic features in a same semantic feature pair, a semantic similarity corresponding to the semantic feature pair;
fusing semantic similarities respectively corresponding to a same positive node pair and corresponding negative node pairs, to obtain a fusion similarity corresponding to the positive node pair, a negative node pair corresponding to the positive node pair being a negative node pair having an overlapping node with the positive node pair;
obtaining, based on a difference between a semantic similarity and a fusion similarity that correspond to a same positive node pair, a node sub-loss corresponding to the positive node pair; and
obtaining the node loss based on a node sub-loss corresponding to each positive node pair.

20. A non-transitory computer-readable storage medium containing computer-readable instructions that, when being executed, cause at least one processor to perform:
obtaining a media search graph, the media search graph comprising a query node corresponding to a query, a media node corresponding to media data, and an association node corresponding to association data, and the association data comprising data associated with at least one of the query or the media data;
obtaining a plurality of first training sample pairs from the media search graph, the plurality of first training sample pairs comprising a positive node pair and a negative node pair, the positive node pair comprising a query node and a media node that are connected to each other in the media search graph, and the negative node pair comprising a query node and a media node that are randomly combined in the media search graph;
sampling the media search graph based on meta-paths respectively corresponding to the query and the media data, to obtain sampling sub-graphs respectively corresponding to the query node and the media node in the first training sample pair, the meta-path being a sampling path starting from the query node or the media node in the media search graph;
inputting, to an initial graph neural network, the sampling sub-graphs respectively corresponding to the query node and the media node in the first training sample pair, to obtain respective initial semantic features of the query node and the media node in the first training sample pair, and form a semantic feature pair corresponding to the first training sample pair; and
training the initial graph neural network based on a difference between semantic feature pairs corresponding to the positive node pair and the negative node pair, to obtain a target graph neural network, the target graph neural network being configured to determine a target semantic feature corresponding to a query node or a media node.
